(19) United States
(12) Patent Application Publication
(10) Pub. No.: US 2025/0147328 A1
(43) Pub. Date: May 8, 2025

(54) BIOMETRIC SYSTEM FOR XR HEAD-MOUNTED DISPLAY

(71) Applicant: Hongquan SHEN, Guiyang (CN)

(72) Inventors: Cheng JIN, Guiyang (CN); Hongquan SHEN, Guiyang (CN); Yang KONG, Guiyang (CN)

(21) Appl. No.: 19/004,794

(22) Filed: Dec. 30, 2024

Related U.S. Application Data
(63) Continuation of application No. PCT/CN2023/103759, filed on Jun. 29, 2023.

(30) Foreign Application Priority Data
Oct. 31, 2022 (CN) 202211348566.4
Apr. 28, 2023 (CN) 202310479638.7

(51) Int. Cl. G02B 27/01

(52) U.S. Cl. CPC G02B 27/0179; G02B 27/0172; G02B 2027/0187

(57) ABSTRACT

An eye/iris biometric system for an extended reality (XR) head-mounted display is provided. The system includes an eye/iris imaging optical unit, a display imaging optical unit, a near-infrared illumination optical unit, and an eye/iris image imaging control unit mounted in the head-mounted display. The eye/iris imaging optical unit is used for physical imaging of near-infrared incident light of an eye/iris. For the display imaging optical unit, an image display source image is emitted to the human eye for image projecting by optical path imaging of a display imaging assembly. The display imaging assembly controls an illumination radiation angle and an illumination angle of emergence of a light-emitting diode (LED) by an angle optical assembly to generate related near-infrared light emitted to the human eye. The eye/iris image imaging control unit controls the eye/iris imaging optical unit and the near-infrared illumination optical unit to generate an eye/iris image.

### CROSS REFERENCE TO RELATED APPLICATIONS

This application is a continuation application of International Patent Application No. PCT/CN2023/103759, filed on Jun. 29, 2023, which itself claims priority to and benefit of Chinese Patent Application No. 202211348566.4 filed on Oct. 31, 2022, and Chinese Patent Application No. 202310479638.7, filed on Apr. 28, 2023, both in the State Intellectual Property Office of P. R. China. The disclosure of each of the above applications is incorporated herein by reference in its entirety.

### TECHNICAL FIELD

The present application relates to the field of individual biometrics, and in particular to a biometric system for an extended reality (XR) head-mounted display.

### BACKGROUND ART

An ultra-short focus optical path is a development trend of extended reality (XR). For example, for a virtual reality (VR) head-mounted display form device, an ultra-short MFL is less than 3 mm, an ultra-short TTL is less than 25 mm, and an ultra-short focal length is less than 23 mm. An ultra-short imaging distance is a new challenge for integrating eye/iris imaging configuration on the VR head-mounted display.

AR head-mounted form requires substantial transparency to an exterior environment, so the challenges are greater, which include complex and powerful stray light interference in an outdoor environment.

In addition, influence of specular reflection light interference caused by wearing various optical power/diopter curved surface glasses on the eye/iris image quality also needs to be overcome.

Furthermore, when a human eye observes an XR display content, a rapid movement of a fixation point causes rapid physiological rotation of a human eyeball, the speed is up to 900 degrees/second. The eyeball movement blur caused by the rapid eyeball rotation directly affects the quality of the formed eye/iris image, resulting in failure of identity authentication.

For an optical imaging system multiplexing eye tracking (ET), only the pupil and a central position of a reflected light spot in an imaging image are extracted, which obviously does not have strict requirements on the image quality, but the individual eye/iris biological features across the complex populations are to extract an image detail texture, which obviously has stricter requirements on the image quality.

At present, an overall coupling optimization design of an eye/iris optical imaging system and a head-mounted display optical imaging system needs to be achieved, and the performance of each unit and the whole needs to be improved. Specific parameters and technical indicators of key techniques included in the technical features need to be known, and a related systematic global coupling relationship between the technical parameters is more important.

On this basis, it is necessary to optimize the eye/iris imaging image quality, improve an eye/iris imaging image speed and improve a recognition rate.

### SUMMARY

The embodiments of the present application is to provide a biometric system for an extended reality (XR) head-mounted display, which optimizes the eye/iris imaging image quality, and improves an eye/iris imaging image speed and a recognition rate, so as to overcome the above-mentioned defects.

The biometric system of the embodiments of the present application includes, but is not limited to, individual activity biological features such as eye/iris, retina, subcutaneous tissue of eyes, ophthalmic artery/vein, and sclera.

The biometric system for an XR head-mounted display of the embodiments of the present application includes an eye/iris imaging optical unit, a display imaging optical unit, a near-infrared illumination optical unit, and an eye/iris image imaging control unit mounted in the head-mounted display, where the near-infrared illumination optical unit is located outside a field of view for observation, FOVd, of the display imaging optical unit, which is invisible in nature related to a human eye observation image and is located on one side (such as left or right side, lower left side or lower right side) of the display imaging optical unit. The eye/iris imaging optical unit includes an image imaging sensor, an imaging lens, and a near-infrared optical filter for physical imaging of human eye/iris near-infrared incident light. The display imaging optical unit includes an image display source and a display imaging assembly, and an image of display source image is emitted to a human eye for image projecting by means of optical path imaging of the display imaging assembly. The display imaging assembly includes a virtual reality (VR) eyepiece imaging optical assembly and an augmented reality (AR) lens imaging optical assembly. The near-infrared illumination optical unit includes a light-emitting diode (LED) and an angle optical assembly, where an illumination radiation angle and an illumination angle of emergence (exit angle) of the LED are controlled by means of the angle optical assembly to generate related near-infrared light to be emitted to the human eye for illuminating an eye/iris. The eye/iris image imaging control unit is configured to control the eye/iris imaging optical unit and the near-infrared illumination optical unit to generate an eye/iris image in a joint imaging mode.

The biometric system for an XR head-mounted display of the embodiments of the present application includes direct imaging of the eye/iris imaging optical unit is from near-infrared light emitted from the eye/iris, or indirect imaging from the near-infrared light emitted from the eye/iris is achieved by means of reverse optical/optical path conversion. The reverse optical/optical path conversion is employed to provide the combined virtual object distance.

Direct imaging is achieved by means of the eye/iris imaging optical unit, and a predetermined angle conversion optical element is mounted in front of the eye/iris imaging optical unit to perform combined optical imaging.

The biometric system for an XR head-mounted display of the embodiments of the present application includes direct illumination of the near-infrared illumination optical unit is emitted to the eye/iris or indirect illumination of the near-infrared light emitted to the eye/iris is achieved by means of forward optical/optical path conversion. The forward optical/optical path conversion is employed to provide the combined virtual object distance.

The biometric system for an XR head-mounted display of the embodiments of the present application includes measurement of individual biological activity.

The biometric system for an XR head-mounted display of the embodiments of the present application includes measurement of physiological state data of biological individuals for individual health state inspection and establishment of a historical data record file.

Compared with the prior art, the configuration of the embodiments of the present application obviously have the advantages and beneficial effects. It can be seen from the above the technical solutions: in the embodiments of the present application, an illumination radiation angle and an illumination angle of emergence of the LED are controlled by the near-infrared illumination optical unit by means of the angle optical assembly to generate related near-infrared light to be emitted to the human eye for illuminating the eye/iris. The eye/iris image imaging control unit may be configured to control the eye/iris imaging optical unit and the near-infrared illumination optical unit to generate the eye/iris image in the joint imaging mode. The system can be applicable to an ultra-short MFL/TTL, an ultra-short focus, and an ultra-short imaging distance of various head-mounted display form devices in terms of the problem about integrating eye/iris imaging configuration on the head-mounted display. The problem that the quality of the formed eye/iris image is affected by interference of an exterior environment including complex and powerful stray light in an outdoor environment is solved. In addition, the problem that the eye/iris image quality is affected by specular reflection light interference formed by wearing various optical power/diopter curved surface glasses is solved. Furthermore, the problem that when the human eye observes an XR display content, a rapid movement of a fixation point causes rapid physiological rotation of the human eyeball, and consequently, the formed eye/iris image quality is affected by eye movement blur caused by the rapid eyeball rotation is solved. More importantly, an overall coupling optimization design of an eye/iris optical imaging system and a head-mounted display optical imaging system is achieved, and the performance of each unit and the whole is improved. The technical features include specific parameters and technical indicators relating to key techniques, and a more important related systematic global coupling relationship between the technical parameters. Finally, on this basis, the eye/iris imaging image quality is optimized, and an eye/iris imaging image speed and a recognition rate are improved.

### BRIEF DESCRIPTION OF THE DRAWINGS

FIG. 1 is a schematic diagram of a VR form head-mounted display in example.

FIG. 2 is a schematic diagram of an AR form head-mounted display in example.

FIG. 3 and FIG. 4 are schematic diagrams for reverse optical/optical path conversion of a VR form head-mounted display in example.

FIG. 5 and FIG. 6 are schematic diagrams for reverse optical/optical path conversion of an AR form head-mounted display in example.

FIG. 7 is a schematic diagram for an optical waveguide of an AR form head-mounted display in example.

FIG. 8a/8b is a schematic diagram for states of polarization of metasurface element, metalens.

FIG. 9 is a logical time sequence relation diagram of an image frame period parallel synchronization logical time sequence imaging working mode method.

FIG. 10a is a schematic diagram for the angle (ωi/ωo) conversion relationship graphically.

FIG. 10b is a schematic diagram for the tracing rays of the metasurface elements with eye/iris joint imaging mode.

FIG. 11 is a schematic diagram for the tracing rays of the metasurface element with eye/iris illuminating.

### REFERENCE NUMERALS IN THE FIGURES

100 display body
101 display imaging optical unit
102 central optical axis of display imaging optical unit
103 eye/iris imaging optical unit
104 near-infrared illumination optical unit
105 human eye
106 imaging region of eye/iris imaging optical unit/illumination region of near-infrared illumination optical unit
107 eyebox of display imaging optical unit
108 illumination angle of emergence of near-infrared illumination optical unit
109 imaging incident angle of eye/iris imaging optical unit
110 field of view for observation, FOVd, of display imaging optical unit
111 field of view for illumination, FOVr, of near-infrared illumination optical unit
112 field of view for imaging, FOVi, of eye/iris imaging optical unit
301 VR eyepiece imaging optical assembly
302 human eye virtual image
303 eye/iris imaging optical unit
304 near-infrared illumination optical unit
305 human eye
306 combined virtual object distance
307 image display source
309 imaging incident angle of eye/iris imaging optical unit
401 AR lens imaging optical assembly
402 human eye virtual image
403 eye/iris imaging optical unit
404 near-infrared illumination optical unit
405 human eye
406 combined virtual object distance
501 optical waveguide optical out-coupling (out-coupler)
502 AR optical waveguide
503 eye/iris imaging optical unit
504 AR lens imaging optical assembly
505 human eye
506 optical waveguide optical in-coupling (in-coupler)
510 field of view for imaging, FOVi, of eye/iris imaging optical unit
513 AR spectacle frame
601 sensor pixel unit array
602 metasurface lens, metalens, element unit array
700 LED source
701 metasurface
702 object plane of eye/iris
704 near-infrared illumination optical unit
800 image plane of eye/iris
801 metasurface element metalens
802 metasurface element metaconverter

### DETAILED DESCRIPTION OF THE EMBODIMENTS

The exemplary examples will be described in detail herein and shown in the accompanying drawings exemplarily. When the following descriptions relate to the accompanying drawings, unless otherwise specified, the equivalent numeral in different accompanying drawings denotes the equivalent or similar element. The embodiments described in the following exemplary examples do not denote all the embodiments consistent with the present application. On the contrary, they are merely instances of an apparatus and a method consistent with some aspects of the present disclosure as detailed in the appended claims. In the description of the present disclosure, it is to be noted that the terms “central”, “upper”, “lower”, “front”, “behind”, “left”, “right”, “vertical”, “horizontal”, “top”, “bottom”, “inner”, “outer”, “axial orientation”, “radial orientation”, “inside”, “side”, etc. indicate azimuthal or positional relations based on those shown in the accompanying drawings only for facilitating the description of the present disclosure and for simplicity of description, and are not intended to indicate or imply that the referenced apparatus or element may have a particular orientation and be constructed and operative in a particular orientation, and thus may not be construed as a limitation on the present disclosure.

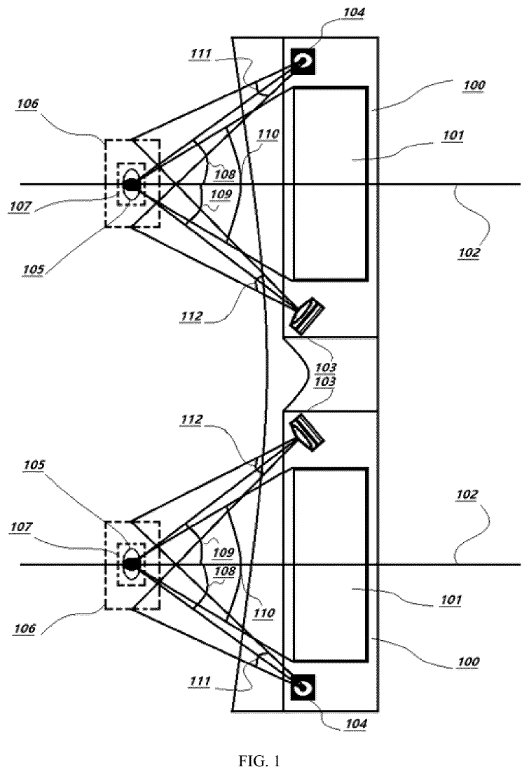

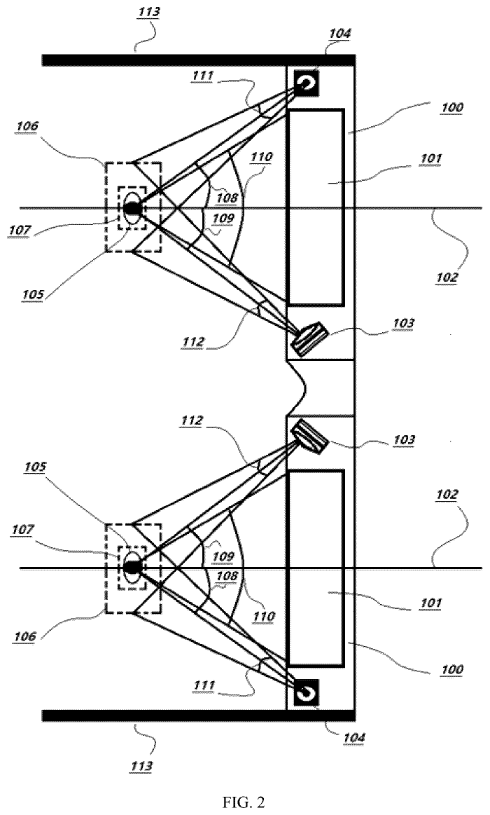

As shown in FIG. 1 and FIG. 2, a biometric system for an extended reality (XR) head-mounted display includes an eye/iris imaging optical unit 103, a display imaging optical unit 101, a near-infrared illumination optical unit 104, and an eye/iris image imaging control unit mounted in a virtual reality (VR)/augmented reality (AR) head-mounted display, where the eye/iris imaging optical unit includes an image imaging sensor, an imaging lens, and a near-infrared optical filter for physical imaging of human eye/iris near-infrared incident light.

The display imaging optical unit includes an image display source and a display imaging assembly, and an image display source image is emitted to a human eye for image projecting by means of optical path imaging of the display imaging assembly. The image display source includes an organic light-emitting diode (OLED), a liquid crystal display (LCD), a microOLED, a microLED, etc., and the display imaging assembly includes a VR eyepiece imaging optical assembly (such as a Fresnel lens, a pancake scheme catadioptric lens+¼ retarder waveplate+reflective polarizer, a liquid crystal lens, a liquid lens, and a metasurface lens, metalens), and an AR lens imaging optical assembly (such as a free-form surface lens and an optical waveguide).

The near-infrared illumination optical unit includes a light-emitting diode (LED) and an angle optical assembly, where an illumination radiation angle and an illumination angle of emergence of the LED are controlled by means of the angle optical assembly to generate related near-infrared light to be emitted to a human eye for illuminating an eye/iris.

The eye/iris image imaging control unit may be configured to control the eye/iris imaging optical unit and the near-infrared illumination optical unit to generate an eye/iris image in a joint imaging mode.

The near-infrared illumination optical unit is located outside a field of view for observation, FOVd, of the display imaging optical unit, which is invisible in nature related to the human eye observation image and is located on one side (such as left or right side, lower left side or lower right side in some preferred examples) of the display imaging optical unit.

Within an eye relief, an illumination region (RXr, RYr) of the near-infrared illumination optical unit is greater than a predetermined illumination region.

The predetermined illumination region is an eyebox (RXeyebox, RYeyebox) of the display imaging optical unit.

The illumination region (RXr, RYr) of the near-infrared illumination optical unit may be configured as follows:

$$RXr = Kxr * RXeye box ,$$

$$RYr = Kyr * RYeyebox ,$$

$$Kxr = [ 1.2 , 3 ] ,$$

$$and$$

$$Kyr = [ 1.2 , 3 ] ;$$

$$or$$

$$RXr = RXeyebox + Fxr * ID ,$$

$$RYr = RYeyebox + Fyr * ID ,$$

$$Fxr = [ 0.2 , 2 ] ,$$

$$Fyr = [ 0.2 , 2 ] ,$$

and
ID represents an iris diameter of the human eye and has an average value of 11 mm.

The illumination region (RXr, RYr) fully considers the Inter-pupillary distance (IPD) difference between the populations and a boundary margin of the illumination region.

The eye/iris imaging optical unit is located outside the field of view for observation, FOVd, of the display imaging optical unit, which is invisible in nature related to the human eye observation image and is located on one side (such as left or right side, lower left side or lower right side in some preferred examples) of the display imaging optical unit.

Within the eye relief, an imaging region (RXi, RYi) of the eye/iris imaging optical unit is greater than a predetermined imaging region.

The predetermined imaging region is the eyebox (RXeyebox, RYeyebox) of the display imaging optical unit.

The imaging region (RXi, RYi) of the eye/iris imaging optical unit may be configured as follows:

$$RXi = Kxi * RXeye box ,$$

$$RYi = Kyi * RYeyebox ,$$

$$Kxi = [ 1.2 , 3 ] ,$$

$$and$$

$$Kyi = [ 1.2 , 3 ] ;$$

$$or$$

$$RXi = RXeyebox + Fxi * ID ,$$

$$RYi = RYeyebox + Fyi * ID ,$$

$$Fxi = [ 0.2 , 2 ] ,$$

$$Fyi = [ 0.2 , 2 ] ,$$

and
ID represents an iris diameter of the human eye and has an average value of 11 mm.

The imaging region (RXi, RYi) fully considers the Inter-pupillary distance, IPD, difference between the populations and a boundary margin of the imaging region.

The illumination region of the near-infrared illumination optical unit covers and is greater than the imaging region the eye/iris imaging optical unit.

A field of view for illumination (FOI), FOVr of the near-infrared illumination optical unit covers and is greater than a field of view for imaging, FOVi, of the eye/iris imaging optical unit.

The field of view for illumination, FOVr, of the near-infrared illumination optical unit may be configured with field of views in XY horizontal and vertical orientations, FOVxr and FOVyr, where

$$FOVxr = 2 * arc tan ( 1 / 2 * RXr / Reyerelif * cos θ r ) ,$$

$$and$$

$$FOVyr = 2 * arc tan ( 1 / 2 * RXr / Reyerelif * cos θ r ) .$$

The field of view for imaging, FOVi, of the eye/iris imaging optical unit may be configured with field of views in XY horizontal and vertical orientations, FOVxi and FOVyi, where

$$FOVxi = 2 * arc tan ( 1 / 2 * RXi / Reyerelif * cos θ i ) ,$$

$$and$$

$$FOVyi = 2 * arc tan ( 1 / 2 * RXi / Reyerelif * cos θ i ) .$$

The near-infrared illumination optical unit controls the field of view for illumination, FOVr, of the near-infrared illumination optical unit by means of the illumination radiation angle.

The eye/iris imaging optical unit controls an imaging region (RXi, RYi) and the field of view for imaging, FOVi, of the eye/iris imaging optical unit by means of pixel resolution and/or object-image spatial resolution, where

$$RXi = PX / PR ,$$

$$RYi = PY / PR ,$$

RXi and RYi represent an imaging region of the field of view for imaging, FOVi, in the X and Y orientations of an object side, with the unit of mm,
PX and PY represent the pixel resolution in the X and Y orientations of an image side, with the unit of pixel, and
PR represents the object-image spatial resolution with the unit of pixel/mm.

An effective focal length, EFL, of the eye/iris imaging optical unit is greater than a predetermined imaging focal length Fi in the eye relief.

The predetermined imaging focal length Fi=PS*PR*Reyerelif, and

PS represents the unit pixel resolution with the unit of um/pixel of the image imaging sensor.

An imaging depth of field, RZ, of the eye/iris imaging optical unit is greater than a predetermined imaging depth of field.

The predetermined imaging depth of field is the eye relief (Reyerelief) of the display imaging optical unit.

The imaging depth of field, RZ, of the eye/iris imaging optical unit may be configured as follows:

$$RZ = Kz * Reyerelif ,$$

$$and$$

$$Kz = [ 1 , 2 ] .$$

The effective focal length EFL for imaging of the eye/iris imaging optical unit, and a variation range of eye/iris diameter imaging limited within the depth of field range are considered.

The eye/iris imaging optical unit may be configured with an imaging incident angle θi, the imaging incident angle is an included angle between a central optical axis of the eye/iris imaging optical unit and a central optical axis of the display imaging optical unit, and the imaging incident angle θi is less than a predetermined imaging incident angle θip, that is,

θi<θip.

The predetermined imaging incident angle θip ranges from 30 degrees to 60 degrees, and θip=FOVi/2.

The near-infrared illumination optical unit may be configured with an illumination angle of emergence θr, the illumination angle of emergence is an included angle between a central optical axis of the near-infrared illumination optical unit and a central optical axis of the display imaging optical unit, and the illumination angle of emergence θr is greater than a predetermined illumination angle of emergence θrp, that is,

θr>θrp or θr<θrp.

The predetermined illumination angle of emergence θrp ranges from 30 degrees to 60 degrees, and θrp=FOVr/2.

The illumination angle of emergence θr of the near-infrared illumination optical unit is greater than the imaging incident angle θi of the eye/iris imaging optical unit, that is, θr>θi.

In some particular examples, when no optical power/diopter curved glasses are worn, in FIGS. 1 and 2, related to the central optical axis of the display imaging optical unit, the near-infrared illumination optical unit and the eye/iris imaging optical unit are located on same side positions (for example, the left/right side, or the lower left side/the lower right side), and an optical imaging eye/iris image effect is equivalent to that when the two units are located on the opposite side. It is objective that the opposite-side position may be configured with higher uniformity of related illumination RI compared with that of the same-side position.

And, in the embodiments of the present application, in order to eliminate or reduce optical imaging interference caused by specular total reflection on surfaces of wearable optical power/diopter curved surface glasses or complex ambient/internal light reflection, related to the central optical axis of the display imaging optical unit, the effect when the near-infrared illumination optical unit and the eye/iris imaging optical unit are located on the opposite side position has the advantage over that when the two units are located on same side positions based on the position combination configuration rule, and in some examples, the position combination configuration of the near-infrared illumination optical unit and the eye/iris imaging optical unit is that the two units are located on the opposite side position of a nose bridge or lower side. In preferred example, the eye/iris imaging optical unit is located on the nose bridge side position or the lower side position, and the near-infrared illumination optical unit is is located on the opposite side position.

Moreover, the illumination angle of emergence θr of the near-infrared illumination optical unit is greater than the imaging incident angle θi of the eye/iris imaging optical unit.

Relatively speaking, the greater the illumination angle of emergence θr of the near-infrared illumination optical unit is, and the lower the imaging incident angle θi of the eye/iris imaging optical unit is, the better the effect of eliminating or reducing the optical imaging interference is, which is more important.

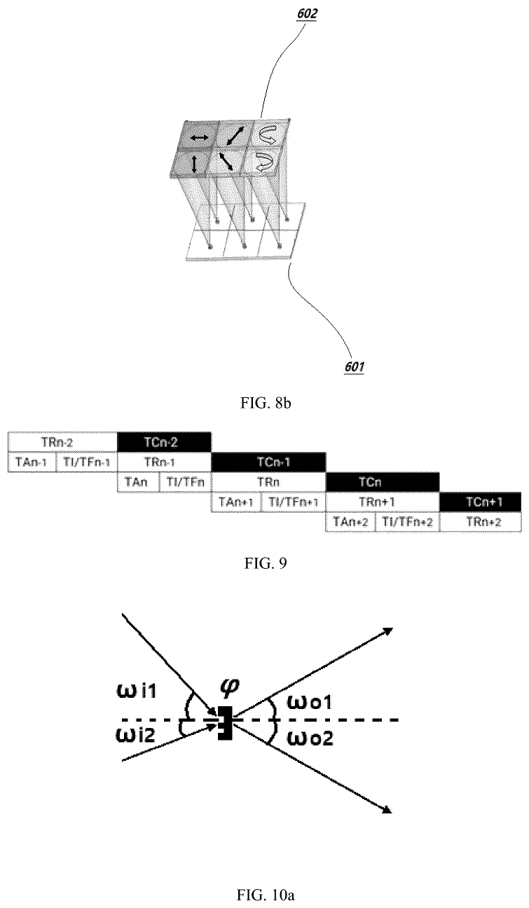

In some embodiments, as shown in FIG. 8, the meta-atom of a metasurface lens element unit array 602 for tunable the optical phase is simulated by a finite difference time domain (FDTD) method to solving the Maxwell boundary equation. By tunning the phase of the wavefront with different arrangement orientations, spacings, heights, rotation angles and/or lengths of the subwavelength nanostructures, so that the light waves of specific wavelength are respectively guided to the predetermined focal plane of sensor pixel unit array 601.

The meta-atom includes the orientation angle of the subwavelength nanostructures in response to a specific polarization state, so that the light waves of the related orientation angle are passed, and the light waves of other orientation angles are blocked and shielded.

In some examples, the eye/iris imaging optical unit of the embodiments of the present application is combined with the near-infrared illumination optical unit to provide a related combined polarization state in a specific orientation of an orthogonal state, thereby eliminating interference of specular reflection light in the related polarization orientation on the surfaces of the worn glasses and in external environment/ambient light. As shown in FIG. 8a, a sensor pixel unit array 601 of the eye/iris imaging optical unit related covers a metasurface lens, metalens, element unit array 602. The metasurface lens, metalens, element unit array 602 may be configured to provide a control incident light phase and a polarization state to be physically focused on the sensor pixel unit, the incident light specific polarization state is focused to the related 601 by means of 602, each related metasurface lens element unit and the sensor pixel unit may be configured to be in the equivalent polarization state, or furthermore, each related metasurface lens element unit and the sensor pixel unit may be configured to be in different polarization states. Schematically, 6 units are shown in FIG. 8. The related metasurface lens element unit and the sensor pixel unit may be configured to be in the equivalent polarization state and may also be separately configured to be in a 0/30/60/90/120/150-degree orientation polarization state to generate a multiple-orientation polarization state imaging attribute, where 0/90, 30/120, and 60/150 are separately configured as orthogonal state combinations, which can provide more imaging image polarization information attributes for individual biological assay, including, but not limited to the biological features which include individual activity, such as an eye/iris, a retina, subcutaneous tissue of eyes, an ophthalmic artery/vein, and a sclera. For example, on the basis of imaging of the biological features of the subcutaneous tissue of eyes and the ophthalmic artery/vein, a higher optical quality image can be provided by means of orthogonal polarization state combination imaging.

Schematically, In an example, 6 units are shown in FIG. 8b. The related metasurface lens element unit and the sensor pixel unit may be configured to be in the equivalent polarization state and may also be separately configured to be in a 0/45/90/135/LCP/RCP orientation polarization state to generate a multiple-orientation polarization state imaging attribute, where 0/90, 45/135,LCP/RCP are separately configured as orthogonal state combinations,

As further shown in FIG. 8a, in the example of the embodiments of the present application illustrates the metasurface element for joint imaging mode. The metasurface element 602 integrated with metapolarizer and metalens is configured for polarizing and focusing to image plane 800 by joint imaging mode.

As mentioned above, the metasurface elements metapolarizer and metalens are combined with the phase modulation of the wavefront by tunning with different arrangement orientations, spacings, heights, rotation angles, lengths of the subwavelength nanostructures.

In an example, the specific linearly polarizer based on all-dielectric diatomic metasurfaces for an operating wavelength of λ=940 nm (NIR narrow band) comprises a structure of the nanocube phase-shift meta-atom (PM) and a structure of the nanocylindrical without phase shift meta-atom (CM). By tuning the rotation of the PM to specific orientation angle ψ, the size of the CM and the spatial distance of the PM and CM with appropriate parameters, the all-dielectric diatomic metasurface manipulates arbitrary angle of polarization.

The metasurface element (metapolarizer) shown in FIG. 8 consisted of the period unit cell. It can convert random light into linear polarized light with specific orientation angle ψ, such as 0/30/60/90/120/150 degrees. The unit cell comprises one PM and one CM, made of TiO2, which are placed on a SiO2 substrate.

Jones matrix of CM is functionally equivalent to rotationally symmetrical unitary 0 phase retarder without phase shifting between two orthogonal axis (x-y).

PM is located at the specific orientation angle ψ related to the x-axis of the unit cell of metasurface with π phase shifting between two orthogonal axis (x-y), and Jones matrix of PM is functionally equivalent to π phase retarder (½ wave plate). PM and CM combination can be equivalent to a linear polarizer with a polarization angle (ψ specific orientation angle of PM).

In embodiments of the present application, to find spatial structural parameters of designing a diatomic metasurface composed of PM and CM, finite-difference time-domain (FDTD, Lumerical Solutions) simulations are performed. The spatial structural parameters of designing include but not limited to, the lattice of diatomic meta-atoms P=[λ/2,λ/sqrt(2)]nm (Nyquist principle), equivalent height of PM and CM H=[λ/2,λ/(n−1)]nm, the length and width of the PM L/W=[100,P−100]nm, the radius of CM R=[100,P−100]nm.

For efficient implementation of various phase modulation mechanisms, high-refractive-index dielectrics (n around 2.0 or higher) are preferred. Common candidate materials include titanium dioxide (TiO2), hafnium oxide (HfO2), gallium nitride (GaN), and silicon nitride (SiNx). For examples operating in the NIR wavelength, silicon (Si), which exhibits a high refractive index (n>3.5) and acceptable extinction coefficient, can be used as well. Certain low-refractive-index (n<2.0) dielectrics, such as silicon dioxide (SiO2) and polymers, can also be employed to construct metasurfaces based on the geometric phase or propagation phase. In order to compensate for their related low refractive index, high-aspect-ratio structures are typically required. Precisely patterning the aforementioned materials into high-aspect-ratio and low-loss subwavelength nanostructures is essential to high-performance metasurface operation. In conventional fabrication processes, the designed metasurface patterns are first created in the resist layer through deep ultraviolet (DUV) or electron beam (e-beam) lithography and then transferred onto the target dielectric layer through dry etching. Nanoimprint lithography (NIL), which generates nano- to micro-scale structures through mechanical pressing with the aid of heating or UV radiation, has been exploited as an alternative method for low-cost and high-throughput metasurface fabrication over large areas.

In embodiments of the present application, the metasurface elements (metapolarizer, metacoupler, metalens, metaconverter, etc) for the eye/iris illumination optical unit (LED) and/or imaging optical unit (CMOS sensor, etc) are integrated with WLO (Wafer Level Optics) flat/planar optics manufacturing technology by standardized CMOS compatible semiconductor platform.

In embodiments of the present application, the basic principles of designing for metasurface element metalens is configured with the phase modulation function φ (following equation) by giving focal length f, numeric aperture NA,FOV(FOVi,FOVr etc), or angular range of incident rays within diffraction limited to image plane. The simulation software (Zemax/CodCode V/Optics studio) traces the incident rays and tunes the oder coefficients a n to minimize the PSF on the image plane within diffraction limited (within diameter D=2.44λ/NA).

$$φ ( r ) = - 2 π * / λ * [ sqrt ( {r}^{2} + {f}^{2} ) - f ]$$

$$φ ( r ) = {\sum }_{n} {{a}_{n} ( \frac{r}{R} )}^{2 n}$$

where
R means normalized radius of phase modulation function, r means argument radius of phase modulation function, an means order coefficient of phase modulation function, 2n means order of Taylor expansion of phase modulation function, it only considers even terms, due to phase profile is radially symmetric.

Certainly, different combinations, such as 0/45/90/135-degree orientation polarization states are also be understood in the equivalent way, where 0/90 and 45/135 are separately configured as orthogonal combinations.

In the equivalent way, the near-infrared illumination optical unit can also provide related multiple-orientation polarization state illumination by means of the metasurface lens, metalens. In some examples, the near-infrared illumination optical unit provides a 0 and/or 90-degree (the equivalent and/or orthogonal) polarization state combination attribute corresponding to the eye/iris imaging optical unit, and the combination attribute includes, but is not limited to, 0/45/90/135/LCP/RCP.

Furthermore, the metasurface element, metalens further provides emergent light flood illumination for the near-infrared illumination optical unit to generate a high-uniformity optical radiation intensity distribution within the predetermined field of view for illumination, FOVr, of emergent light. In some examples, a rectangular light spot for projecting the FOVr high-uniformity radiation intensity distribution improves the related illumination RI within the field of view FOVi range.

Due to a limitation on a mounting position, which requires the near-infrared illumination optical unit to be located outside the field of view for observation, FOVd, of the display imaging optical unit, the illumination angle of emergence of the near-infrared illumination optical unit satisfies θr>FOVd/2 based on such a structure limitation, which completely satisfies the condition of 30-60 degrees in practice. In view of the situation that if the illumination angle of emergence θr of the near-infrared illumination optical unit is too large, the related illumination RI, cos³ θr is reduced, and a light energy utilization rate is also essentially reduced, 60 degrees should be an upper limit. A related illumination RI fixed model correction compensation process may be employed in the range of 45-60 degrees.

In the equivalent way, due to a limitation on a mounting position, which requires the eye/iris imaging optical unit to be located outside the field of view for observation, FOVd, of the display imaging optical unit, the imaging incident angle of the eye/iris imaging optical unit satisfy θi>FOVd/2 based on such a structure limitation.

In particular, when limitation is generated in both the X and Y orientations, such an ultra-large imaging incident angle non-coaxial (off-axis) imaging system causes imaging performance problems, such as spatial perspective transformation and distortion, and related illumination. Although a spatial perspective transformation or fixed distortion model correction compensation method can be used to partially reduce the optical distortion caused by a too large spatial field of view in a limited extent, a related illumination effect still exists. Especially for an eye/iris recognition application algorithm in machine vision, the detail pixel texture contrast and pixel TV distortion requirements of imaging eye/iris images are required.

Therefore, reduction of the imaging incident angle of the eye/iris imaging optical unit is one of the objectives of the embodiments of the present application.

As shown in FIG. 1/2 in the example of the embodiments of the present application, direct imaging of the eye/iris imaging optical unit is from near-infrared light emitted from the eye/iris.

When the imaging incident angle θi of the eye/iris imaging optical unit exceeds the predetermined imaging incident angle θip (θi>θip), the eye/iris imaging optical unit increases the imaging region (RXi, RYi) and the field of view for imaging, FOVi. In some particular examples, the imaging incident angle θi is reduced and satisfies θi<θip by improving the pixel resolution (PX, PY) in the X and Y orientations of the eye/iris imaging optical unit and/or reducing the object-image spatial resolution PR of the eye/iris imaging optical unit.

Furthermore, exemplary, 60 degrees decrease to 45 or 30 degrees to related increase the pixel resolution (400 pixel, 400 pixel) in the X and Y orientations of the eye/iris imaging optical unit to (512 pixel, 512 pixel) or (600 pixel, 600 pixel), or reduce the object-image spatial resolution, 16 pixel/mm, of the eye/iris imaging optical unit to 13 pixel/mm or 10 pixel/mm.

The pixel resolution (PX, PY) in the X and Y orientations of the eye/iris imaging optical unit is increased and the object-image spatial resolution PR of the eye/iris imaging optical unit is reduced in a synchronous and combined manner, and 60 degrees decreases to 45 or 30 degrees to increase the pixel resolution (400 pixel, 400 pixel) in the X and Y orientations of the eye/iris imaging optical unit to (460 pixel, 460 pixel) or (512 pixel, 512 pixel) and reduce the object-image spatial resolution, 16 pixel/mm, of the eye/iris imaging optical unit to 14 pixel/mm or 13 pixel/mm.

In the equivalent way, as shown in FIG. 1/2 in the example of the embodiments of the present application, the near-infrared illumination optical unit directly illuminates near-infrared light and emits the near-infrared light to the eye/iris, and the illumination angle of emergence θr of the near-infrared illumination optical unit exceeds the predetermined illumination angle of emergence θrp, that is, θr>θrp.

As a further improved feature of imaging of the eye/iris imaging optical unit of the embodiments of the present application, a predetermined angle conversion optical element is mounted in front (defined according to an optical propagation orientation) of the eye/iris imaging optical unit 103 to perform combined optical imaging. The predetermined angle conversion optical element is explained for a physical action and is defined based on an optical path propagation orientation. Different light incident angles ωi from human eye/iris emission are first incident to the predetermined angle conversion optical element and then emitted to the eye/iris imaging optical unit 103 at a related light angle of emergence ωo. In some examples, the predetermined angle conversion optical element may be configured as follows: the incident angle ωi and the related angle of emergence ωo have a predetermined conversion relationship:

$$tan ω o = tan ω i / ( cos θ i - sin θ i * tan ω i ) ,$$

$$ω i = [ - FOVi / 2 , FOVi / 2 ] ,$$

and
ωi and ωo take the optical axis of the eye/iris imaging optical unit tilting at an angle of θi as a normal axis of a symmetry center.

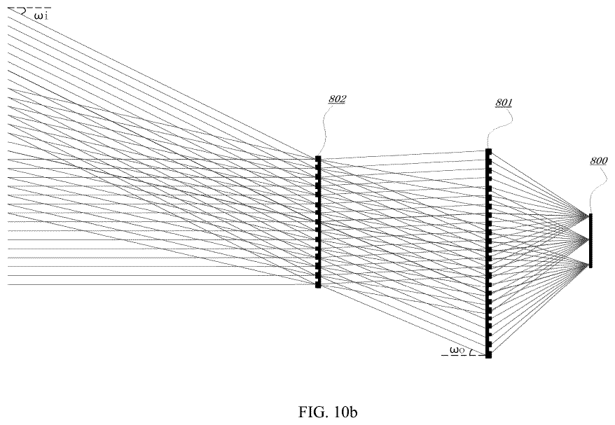

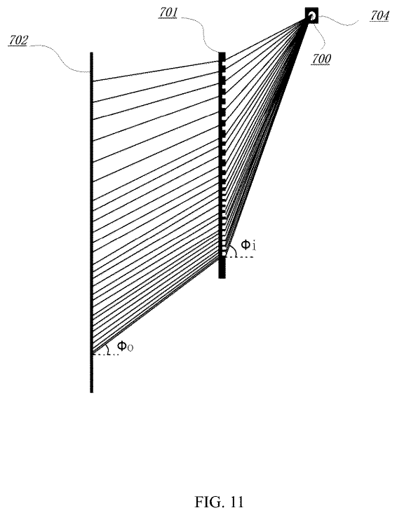

In the example of the embodiments of the present application, As shown in FIG. 10a, illustrates the angle (ωi/ωo) conversion relationship graphically by angular related dimensions, where the dashed line is the normal axis. The principled explanation of the conversion relationship with phase modulation function of the metasurface element metaconverter is functional transmit incident angle ωi1/ωi2 to related angle of emergence ωo1/ωo2 within FOV1 (i.e ωi1 to ωo1,ωi2 to ωo2). The phase modulation of the wavefront φ (phase gradient φ′) is expressed by generalized snell's law: no*sin ωo-ni*sin ωi=λ/2π*φ′.

It is more advantageous to simplify the physical implementation of the off-axis metasurface optical element by means of corresponding to incident angle/angle of emergence ωi/ωo with the optical axis of the eye/iris imaging optical unit tilting at the angle of θi as the normal axis of the symmetry center.

The above-described high-order nonlinear angle conversion relationship corresponding to phase modulation function further simplifies the approximate low-order(phase profile). In some examples, the predetermined angle conversion optical element includes, but not limited to, a metasurface optical element. The metasurface optical element is provided with an tunable sub-wavelength spatial structure, such that the tunable incident angle/angle of emergence conversion degree of freedom range has the advantage over the other optical element.

By means of the incident angle/angle of emergence conversion, inverse transformation of the optical property of an oblique off-axis incident imaging effect can be essentially achieved by the eye/iris imaging optical unit, and the optical properties such as imaging region perspective, and distortion within the range of the field of view for imaging are essentially improved.

As further shown in FIG. 10b, in the example of the embodiments of the present application illustrates the metasurface element for joint imaging mode. The metaconverter 802 is configured for manipulating the conversion relationship and the metalens 801 is configured for focusing to image plane 800 by joint imaging mode. As mentioned above, the metasurface element metaconverter 802 and metalens 801 are combined with the phase modulation of the wavefront by tunning with different arrangement orientations, spacings, heights, rotation angles, lengths of the subwavelength nanostructures.

Further, cascades of the metaconverter 802 and the metalens 801 can be equivalent to individual integrated element.

According to the equivalent principle, a further improved uniform feature of the illumination optical unit of the embodiments of the present application, a predetermined angle conversion optical element is mounted in front (defined according to an optical propagation orientation) of the illumination optical unit 104 to perform combined optical illumination. The predetermined angle conversion optical element is explained for a physical action and is defined based on an optical path propagation orientation. Different angle of incident Φi from illumination optical unit 104 emission are first incident to the predetermined angle conversion optical element and then emitted to the eye/iris at a related angle of emergence Φo. In some examples, the predetermined angle conversion optical element may be configured as follows: the incident angle Φi and the related angle of emergence Φo have a predetermined conversion relationship:

$${cos}^{2} Φ o = cos Φ i ,$$

$$or$$

$${cos}^{3} Φ o = cos Φ i etc .$$

$$Φ o = [ θ r - FOVr / 2 , θ r + FOVr / 2 ] ,$$

and
Φi and Φo take the optical axis of the illumination optical unit tilting at an angle of θr as a normal axis of a symmetry center.

As shown in FIG. 11 in the example of the embodiments of the present application illustrates the angle (Φo/Φi) conversion relationship graphically, showing the relationship between incident angle and angle of emergence by density of ray. The metasurface element metaconverter 701 is configured for manipulating the conversion relationship to illuminating eye/iris. The above-described high-order nonlinear angle conversion relationship corresponding to phase modulation function further simplifies the approximate low-order (4-8order). The phase modulation of the wavefront φ(phase gradient φ′) is expressed by generalized snell's law: no*sin Φo-ni*sin Φi=λ/2π*φ′.

It is more advantageous to simplify the physical implementation of the off-axis metasurface optical element by means of a related incident angle/angle of emergence Φi/Φo with the optical axis of the eye/iris illumination optical unit tilting at the angle of θr as the normal axis of the symmetry center.

In some examples, the predetermined angle conversion optical element includes, but not limited to, a metasurface optical element metaconverter. The metasurface optical element is provided with an tunable sub-wavelength spatial structure, such that the tunable incident angle/angle of emergence conversion degree of freedom range has the advantage over the other optical element.

By means of the incident angle/angle of emergence conversion, inverse transformation of the optical property of an oblique off-axis emergent illumination effect can be essentially achieved by the eye/iris illumination optical unit, and the optical properties such as related illumination RI uniform rate and a light energy utilization rate of illumination region are essentially improved.

As a further improved feature of the embodiments of the present application, indirect imaging from the near-infrared light emitted from the eye/iris is achieved by means of reverse optical/optical path conversion in some particular examples of the embodiments of the present application.

An optical path of the eye/iris imaging optical unit transmits the near-infrared light emitted from the eye/iris by means of the reverse optical refraction and/or reflection conversion of an imaging optical path of the display imaging assembly.

By means of an extended virtual distance of a reverse optical/optical path conversion imaging optical path, the imaging incident angle θi between the eye/iris imaging optical unit and the display imaging optical assembly is reduced. The requirement that θi<θip is satisfied.

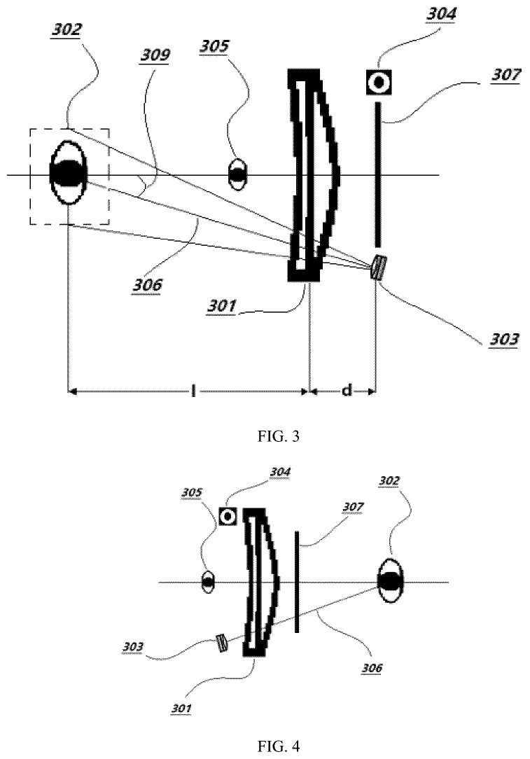

In some particular examples of the embodiments of the present application, the head-mounted display is a VR form head-mounted display. As shown in FIG. 3, the display imaging assembly includes a VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

The liquid crystal lens, the liquid lens, and the metasurface lens, metalens, have electromagnetic tunable varifocal potential, can satisfy user's requirements on different optical power/diopter curved surface adjustment, and can overcome a visual convergence adjustment conflict phenomenon.

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in behind of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.), and is located on the positions, including but not limited to, being in front of or behind of the image display source. By means of such reverse optical/optical path conversion, the imaging optical path is formed by means of refraction of the VR eyepiece imaging optical assembly on indirect imaging, which is from near-infrared light emitted from the eye/iris, of the eye/iris imaging optical unit. By means of an extended combined virtual distance of the imaging optical path, the imaging incident angle θi between the eye/iris imaging optical unit and the VR eyepiece imaging optical assembly is reduced.

In some examples, the eye/iris imaging optical unit is converted to be located inside of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

In some examples, as shown in FIG. 3, reverse optical/optical path conversion is employed to provide the combined virtual object distance 306, thereby achieving reduction within 20 degrees of θi, such as 15/17 degrees or even lower. In fact, the influence of optical properties such as angle perspective and distortion formed by an incident angle (cos 20=0.94) of 20 degrees or below can be substantially ignored related to the imaging image quality used for algorithm processing.

The combined virtual distance of the eye/iris imaging optical unit provide the optical properties needed to essentially manipulate the imaging incident angle θi.

The combined virtual distance refers to a combination between a virtual object distance provided by the imaging optical path of the display imaging assembly and a physical distance from an optical principal plane of the imaging optical path of the display imaging assembly to an optical principal plane of the eye/iris imaging optical unit.

As shown in FIG. 3, the combined virtual object distance s of the eye/iris imaging optical unit is a combination between a virtual object distance l provided by the imaging optical path of the display imaging assembly and a physical spacing distance d from an optical principal plane (principal point) of the imaging optical path of the display imaging assembly to an optical principal plane (principal point) of the eye/iris imaging optical unit, that is, s=(l+d).

The effective focal length EFL for imaging of the eye/iris imaging optical unit may be configured as follows:

$$EFL = β * s / ( β - β1 ) / cos θ i >= β * s / ( β - β1 ) ,$$

where
β=−PR*PS, which is a magnification of a combined imaging vertical axis of the predetermined image quality standard,
β1=f1/(−Reyerelif−p+f1), which is a magnification of a vertical axis provided by the imaging optical path of the display imaging assembly,
f1 is an equivalent focal length of the display imaging assembly, p is a distance from an optical principal point of the imaging optical path of the display imaging assembly and a vertex of a first front surface, and Reyerelif+p is an object distance between the eye/iris and the imaging optical path of the display imaging assembly.

Furthermore, the structural mounting position limits the physical spacing distance g=15 mm between the eye/iris imaging optical unit and the display imaging assembly, and the imaging incident angle θi=arctan(g/s)=20 degrees.
PR=20 pixel/mm, PS=2.5 um/pixel, f1=30 mm, p=2 mm, Reyerelif=13 mm, 1=30 mm, d=10 mm, and

$$EFL = 0.9756 mm / 1.038 mm .$$

The effective focal length EFL for imaging of the eye/iris imaging optical unit for indirect imaging is not significantly increased compared to direct imaging, and mounting can be performed in a display imaging optical unit space in terms of a construction space.

The field of view for imaging, FOVi, of the eye/iris imaging optical unit may be configured with field of views in XY horizontal and vertical orientations, FOVxi and FOVyi, where

$$FOVxi = 2 * arctan ( 1 / 2 * β1 * RXi / s * cos θ i ) , and$$

$$FOVyi = 2 * arctan ( 1 / 2 * β1 * RYi / s * cos θ i ) .$$

In some examples, in an extreme case in which the angle formed by means of direct configuration of the indirect imaging incident angle θi is 0 degree, the combined virtual object distance of the eye/iris imaging optical unit described above supports cancellation of oblique imaging incident angle configuration.

The optical properties such as angle perspective and distortion formed by the imaging incident angle θi are substantially reduced by means of the indirect imaging device of the embodiments of the present application, and moreover, the predetermined image quality requirements are satisfied.

The spatial structure is reasonable and compact. The eye/iris imaging optical unit is located in the space of the display imaging optical unit and is substantially invisible, and the hidden appearance is more in line with ergonomics.

The VR eyepiece imaging optical assembly described above configures optical surfaces with a related adaptive optical power/diopter curve. In some examples, the optical surfaces may include, but not limited to, part or all of the surfaces of optical elements. The provided configuration substantially responds to high transmittance of near-infrared light NIR. In the example, a coating is employed to achieve narrow band 30-60 nm or 800-1000 nm broadband transmittance of over 90%, and reflectivity of below 1% for NIR850/940 nm.

In some examples, a pancake catadioptric optical path may be employed in the eye/iris imaging optical unit, and a reflective polarizer, a ¼ retarder waveplate and a catadioptric lens are used. The near-infrared reflected light of the human eye/iris is naturally polarized or randomly polarized, and propagation of the refractive (Non-Reflecting) optical path has no substantial attenuation, distortion, or wavefront error by optimized optical imaging elements

The specific-orientation polarized light incident to the eye/iris imaging optical unit through the reflective polarizer has special effects and can eliminate interference of specular reflection light in the related polarization orientation on surfaces of worn glasses and in an external environment/internal light in combination with a related polarization state in an orthogonal state orientation of the near-infrared illumination optical unit.

Furthermore, in some examples, reflective polarizer is configured with specific-orientation (P) polarization state for emergent light.

The specific-orientation polarization state of incident light of the eye/iris imaging optical unit is configured with an identical (CP) polarization state, and is used for direct imaging of incident light through the pancake catadioptric optical path without reflection(essentially refraction).

The related orthogonal polarization state of emergent light of the near-infrared illumination optical unit is configured with circular polarization (CP), and is used for direct emergent light through the pancake catadioptric optical path without reflection (essentially refraction). The circular polarization (CP) state is converted to the P polarization state by ¼ retarder waveplate.

In some examples, the configuration of polarization state of the eye/iris imaging optical unit may be omitted.

The above-described the (P) and the (S) polarization state are equivalent substitutions.

Furthermore, in some examples, as shown in FIG. 4, indirect imaging from the near-infrared light emitted from the eye/iris is achieved by means of reverse optical/optical path conversion in some particular examples of the embodiments of the present application.

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in front of or inside of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

The VR eyepiece imaging optical assembly described above configures optical surfaces with a related adaptive optical power/diopter curve. In some examples, the optical surfaces may include, but not limited to, part or all of the surfaces of optical elements. The provided configuration substantially responds to high reflectivity of near-infrared light NIR. In the example, a coating is employed to achieve narrow band 30-60 nm or 800-1000 nm broadband reflectivity of over 90%, and transmittance of below 1% for NIR850/940 nm.

For such a reverse optical/optical path conversion, imaging of the eye/iris imaging optical unit is from the near-infrared light emitted from the eye/iris, which is reflected to form the imaging optical path by means of the VR eyepiece imaging optical assembly. By means of an extended virtual distance of the imaging optical path, the imaging incident angle θi between the eye/iris imaging optical unit and the VR eyepiece imaging optical assembly is reduced.

In some examples, as shown in FIG. 4, reverse optical/optical path conversion is employed to provide a virtual object distance 306, thereby achieving reduction within 20 degrees of θi, such as 15/17 degrees or even lower.

Furthermore, due to the specific-orientation polarization state of the VR eyepiece imaging optical assembly described above, the optical path of the eye/iris imaging optical unit may be multiple refracting and reflecting, which results in an extended virtual distance of the imaging optical path.

The specific-orientation polarized light incident to the eye/iris imaging optical unit can eliminate interference of specular reflection light in the related polarization orientation on surfaces of worn glasses and in an external environment/internal light in combination with a related polarization state in an orthogonal state orientation of the near-infrared illumination optical unit.

Furthermore, the specific-orientation polarization state of incident light of the eye/iris imaging optical unit is configured with the first(P) polarization state, and related orthogonal polarization state of emergent light of the near-infrared illumination optical unit is configured with the second (S) polarization state.

The above-described the first (P) and the second (S) polarization state are equivalent substitutions.

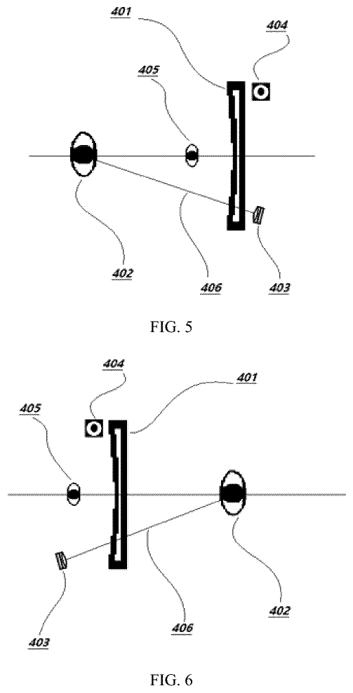

The head-mounted display mentioned in the particular example of the embodiments of the present application is an AR form head-mounted display. As shown in FIG. 5, the display imaging assembly includes an AR lens imaging optical assembly (which may also be a free-form surface lens, a prism, a BB, an optical waveguide, etc.).

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in behind of or inside of an AR lens imaging optical assembly.

For such a reverse optical/optical path conversion, imaging of the eye/iris imaging optical unit is from the near-infrared light emitted from the eye/iris, which is refracted to form the imaging optical path by means of the AR lens imaging optical assembly. By means of an extended virtual distance of the imaging optical path, the imaging incident angle θi between the eye/iris imaging optical unit and the AR lens imaging optical assembly is reduced.

In some examples, as shown in FIG. 5, reverse optical/optical path conversion is employed to provide a virtual object distance 406, thereby achieving reduction within 20 degrees of θi, such as 15/17 degrees or even lower.

The AR lens imaging optical assembly described above configures optical surfaces with a related adaptive optical power/diopter curve. In some examples, the optical surfaces may include, but not limited to, part or all of the surfaces of optical elements. The provided configuration substantially responds to high transmittance of near-infrared light NIR. In the example, a coating is employed to achieve narrow band 30-60 nm or 800-1000 nm broadband transmittance of over 90%, and reflectivity of below 1% for NIR850/940 nm.

Furthermore, the specific-orientation polarization state of incident light of the eye/iris imaging optical unit is configured with first (P) polarization state, and related orthogonal polarization state of emergent light of the near-infrared illumination optical unit is configured with the second (S) polarization state.

The above-described the first (P) and the second (S) polarization state are equivalent substitutions.

Furthermore, indirect imaging from the near-infrared light emitted from the eye/iris is achieved by means of reverse optical/optical path conversion in some particular examples of the embodiments of the present application. As shown in FIG. 6, the eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in front of or inside of an AR lens imaging optical assembly.

For such a reverse optical/optical path conversion, imaging of the eye/iris imaging optical unit is from the near-infrared light emitted from the eye/iris, which is reflected to form the imaging optical path by means of the AR lens imaging optical assembly. By means of an extended virtual distance of the imaging optical path, the imaging incident angle θi between the eye/iris imaging optical unit and the AR lens imaging optical assembly is reduced. In some examples, as shown in FIG. 6, reverse optical/optical path conversion is employed to provide a virtual object distance 406, thereby achieving reduction within 20 degrees of θi, such as 15/17 degrees or even lower.

The AR lens imaging optical assembly described above configures optical surfaces with a related adaptive optical power/diopter curve. In some examples, the optical surfaces may include, but not limited to, part or all of the surfaces of optical elements. The provided configuration substantially responds to high reflectivity of near-infrared light NIR. A coating may also be employed to achieve narrow band 30-60 nm or 800-1000 nm broadband reflectivity of over 90%, and transmittance of below 1% for NIR850/940 nm. The equivalent optical conversion uses a near-infrared thermal reflector, hot mirror, etc. which is placed on an appropriate imaging optical path.

Furthermore, the specific-orientation polarization state of incident light of the eye/iris imaging optical unit is configured with the first(P) polarization state, and related orthogonal polarization state of emergent light of the near-infrared illumination optical unit is configured with the second (S) polarization state. The above-described the first (P) and the second (S) polarization state are equivalent substitutions.

In application of forward optical/optical path conversion with the equivalent principle, as shown in the above example and FIG. 3/5, the near-infrared illumination optical unit 304/404 employs equivalent forward optical/optical path conversion to achieve indirect illumination of near-infrared light emitted to the eye/iris, and is set corresponding to the eye/iris imaging optical unit.

An optical path of the near-infrared illumination optical unit transmits the near-infrared light and emits equivalent to the eye/iris by means of the forward optical refraction and/or reflection conversion of the imaging optical path of the display imaging assembly.

Owing to the forward optical/optical path conversion, the illumination angle of emergence θr between the near-infrared illumination optical unit and the VR eyepiece imaging optical assembly, and the illumination angle of emergence θr between the near-infrared illumination optical unit and the AR lens imaging optical assembly are reduced by means of the extended virtual distance of the illumination optical path.

related, the illumination angle of emergence θr is less than the predetermined illumination angle of emergence θrp, that is, θr<θrp. related illumination RI and a light energy utilization rate of the imaging region within the range of the field of view for imaging are improved.

For some particular examples, as shown in FIG. 3, the virtual distance s2=l2+Reyerelif+p, and

$$l 2 = f 1 * d 2 / ( - d 2 + f 1 ) = β2 * d 2.$$

For some particular examples, f1=30 mm, p=2 mm, Reyerelif=13 mm, l2=30 mm, d2=15 mm, and s2=45 mm, where

d2 is an object distance between the near-infrared illumination optical unit and the display imaging assembly.

The structural mounting position limits the physical spacing distance g2=15 mm between the near-infrared illumination optical unit and the display imaging assembly, and the illumination angle of emergence θr=arctan(β2*g2/s2)=33.6 degrees, which still satisfies the configured optical property, that is, θr>θi.

The field of view for illumination, FOVr, of the near-infrared illumination optical unit may be configured with field of views in XY horizontal and vertical orientations, FOVxr and FOVyr, where

$$FOVxr = 2 * arctan ( 1 / 2 * β2 * RXr / s 2 * cos θ r ) , and$$

$$FOVyr = 2 * arctan ( 1 / 2 * β2 * RYr / s 2 * cos θ r ) .$$

As shown in the above example, the near-infrared illumination optical unit is arranged corresponding to the eye/iris imaging optical unit. It should be specially noted that the position of the near-infrared illumination optical unit should be considered to avoid the emergent light from being focused and guided to a user's retina by a crystalline lens, thereby avoiding occurrence of thermal and retinal radiation damage.

In the embodiments of forward/reverse optical/optical path conversion with the equivalent principle, the near-infrared illumination optical unit and the eye/iris imaging optical unit is located on the positions, including but not limited to, being in front of, or inside of, or behind of optical elements of the display imaging assembly.

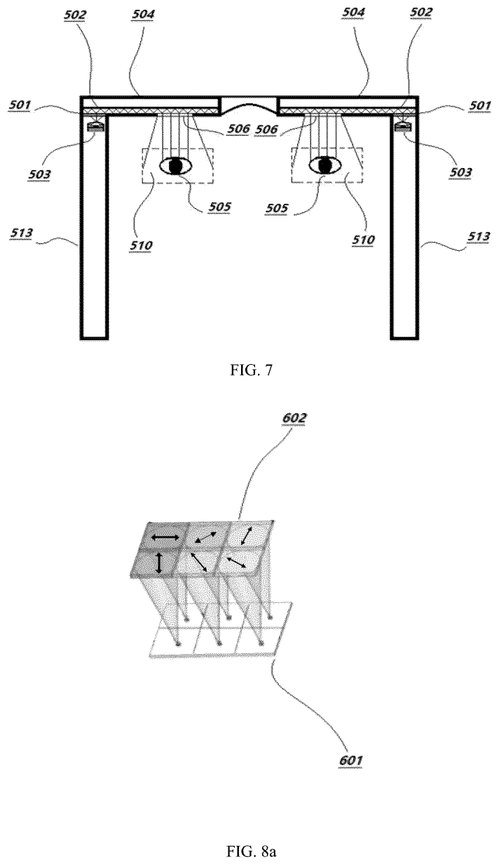

For a further example, in the AR form head-mounted display according to a specific example of the embodiments of the present application, as shown in FIG. 7, the eye/iris imaging optical unit is mounted at a position inside a spectacle frame 513, and the optical path of the eye/iris imaging optical unit transmits the near-infrared light emitted from the eye/iris through the reverse optical reflection conversion of an imaging optical path of an optical waveguide lens. Within the region of the field of view for imaging FOVi 510, of the eye/iris imaging optical unit, the near-infrared light emitted from the eye/iris 505 is coupled into an interior of an optical waveguide 502 by means of optical waveguide optical in-coupling (in-coupler) 506 and is transmitted to an optical waveguide optical out-coupling (out-coupler) 501 to the eye/iris imaging optical unit 503 by means of total reflection, thereby completing the whole optical path imaging process. An important characteristic of the above-described optical path is: the imaging incident angle θi is constant at 0, i.e. a complete ideal front view (coaxial/on-axis).

In some examples, the configuration of the eye/iris imaging optical unit 503 includes, but not limited to, a telephoto imaging telescope combined optical system, and a focal length ratio −f1/f2=angle magnification=1/β=1/(−PR*PS) of front and behind lenses (defined according to the optical path propagation orientation).

In application of forward optical/optical path conversion with the equivalent principle, the near-infrared illumination optical unit 513 is mounted at various positions relative to the eye/iris imaging optical unit. In some examples, the related position may be a peripheral edge of the image display source, and an emergent optical path of the image display source is multiplexed. The optical path of the near-infrared illumination optical unit transmits near-infrared light to the eye/iris by means of the forward optical reflection conversion of the imaging optical path of the optical waveguide, and the near-infrared light emitted by the near-infrared illumination optical unit is coupled into the 502 by means of the in-coupling 501 and is propagated into the out-coupling 506 to reach the region of field of view for illumination, FOVr, of the human eye 505, thereby completing the whole optical path illumination process. One important characteristic of the above-described optical path is: the illumination angle of emergence θr is constant at 0, which results in the introduction of a red eye effect to reduce the contrast of a pupil region. The modification method includes, not limited to: shifting an angle of emergence, adjusting an angle of emergence orientation, etc., and the condition that θr>7 degrees is satisfied.

As shown in the above example, the near-infrared illumination optical unit is arranged corresponding to the eye/iris imaging optical unit. It should be specially noted that the position of the near-infrared illumination optical unit should be considered to avoid the emergent light from being focused and guided to a user's retina by a crystalline lens, and avoiding occurrence of thermal and retinal radiation damage.

In some examples, for different types of optical waveguides, optical in-coupling/optical out-coupling optical elements may include, but not limited to, a surface-relief grating waveguide, a volume holographic grating waveguide, geometric arrays of optical waveguide etc. are of different types by means of specific orientational circular polarization and/or diffraction level in-coupling/out-coupling combinations. Due to the limitation of the total internal reflection TIR angle of the optical waveguide, the incident angle/diffraction angle of the optical waveguide used for FOV of illumination and imaging are also limited. The metasurface optical element(meta-coupler) with phase modulation technology (above-described incident angle/angle of emergence conversion) is provided with an tunable sub-wavelength spatial nanostructure, the meta-coupler tunes an incident angle/angle of emergence conversion to coupling in/out a TIR angle of an optical waveguide within a predetermined FOV of illumination and imaging. such that the degree of freedom of incident angle/angle of emergence has the advantage over the incident/diffraction angle corresponding to a diffractive optical element.

In the embodiments of the present application, in order to achieve optimization of the eye/iris imaging image quality, the eye/iris imaging image quality standards are unified, and imaging system level imaging parameters and technical indicator requirements of the eye/iris imaging optical unit are stipulated to comprise at least one of data attributes:
the eye/iris imaging optical unit may be configured with imaging system pixel TV distortion, Distv<5%@1.0FOVi,
the eye/iris imaging optical unit may be configured with imaging system related illumination, RI=RIled*RIlens,

$$RI > 30 \% @ 1. FOVi ,$$

Riled represents the related illumination when the illumination radiation angle of the near-infrared illumination optical unit is 1.0FOVi, and
RIlens represents the related illumination when the lens field of view for imaging of the eye/iris imaging optical unit is 1.0FOVi.

The eye/iris imaging optical unit may be configured with imaging system MTF=MTFsensor*MTFlens,

$$MTF > 50 \% or e - 1 / 2 \% @ PF = Nyquist / 4 ,$$

$$PF = Nyquist / EPS = 1 / ( 2 * PS * EPS ) , and$$

$$EPS = PR / ( 2 * MTFo ) ,$$

where
PF represents the image spatial resolution/frequency,
MTFsensor represents a modulation transfer function value of the image imaging sensor of the eye/iris imaging optical unit at PF,
MTFlens represents a modulation transfer function value of an imaging lens of the eye/iris imaging optical unit at PF,
MTFo represents a modulation transfer function value of the object spatial resolution/frequency of the eye/iris image quality at predetermined contrast, and
according to eye/iris image quality international standards of ISO/IEC 19794/29794-6, the lowest acceptable permissible MTFo=2 lp/mm@contrast=50% or e-½%.

The minimum acceptable permissible PR=16 pixels/mm.

According to the eye/iris image quality standards in the international standards of ISO/IEC 19794/29794-6, EPS=4 pixels, i.e. 4 pixel scales. The EPS pixel scale is an important basic parameter for establishing a conversion association between the object spatial resolution and the image pixel spatial resolution of the eye/iris image quality. The main reason lies in that eye/iris image acquisition and subsequent image processing, image quality evaluation and algorithm recognition are all established on the basis of an image pixel unit, and the quality of an acquired eye/iris image can satisfy a predetermined standard by means of an image quality parameter established by means of the EPS association.

The embodiments of the present application, the minimum acceptable permissible PR and the lowest acceptable permissible MTFo may include, but is not limited to eye/iris image quality international standards of ISO/IEC 19794/29794-6. In some examples, the EPS may be configured with PR<16 pixels/mm and MTFo<2 lp/mm@contrast=50% or e-½%, such as PR=10 pixels/mm, MTFo=1 lp/mm@contrast=50% e-½%, EPS=5 pixels scale, the MTF may be configured to MTF>50% or e-½% @PF=Nyquist/5.

In some examples, further, the EPS may be configured with PR=20 pixels/mm, MTFo=1 lp/mm@contrast=50% e-½%, EPS=10 pixels scale, the MTF may be configured to MTF>50% or e-½%@PF=Nyquist/10.

The eye/iris imaging optical unit may be configured with an aperture F of the imaging system, where
a range of F=m*PS is PS/um*EPS/8<F<PS/um*EPS/2,

$$F = m * PS = [ 1 / 8 , 1 / 2 ] * ( PS * PR / MTFo ) / um ;$$

$$m = [ EPS / 8 , EPS / 2 ] / um .$$

The depth of field, image imaging luminance and image imaging quality requirements have been comprehensively considered in an optimized manner.

The eye/iris imaging optical unit may be configured with the imaging depth of field, DOFi=RZ>=2*m*EPS/PR²=m/(MTFo*PR)=[ 1/16,¼]*(1/MTFo²)/um.

Although fixation point stabilization can be made in the XR display content when biometric authentication is performed in actual scenarios, for example, UI is fixed to as to reduce the eyeball movement angular velocity. The eyeball movement angular velocity cannot be eliminated when it is adapted to use by complex populations, which includes physiological different muscle control changes.

The embodiments of the present application solve the problems that when the human eye observes the XR display content, a rapid movement of a fixation point causes rapid physiological rotation of a human eyeball, the eyeball movement blur caused by the rapid eyeball rotation directly affects the formed eye/iris image quality, resulting in failure of identity authentication are solved.

Detailed description will be further made below.

The imaging system of the eye/iris imaging optical unit may be configured as follows:
synchronization pulse global exposure period time TI is equal to LED synchronization pulse illumination radiation period time TF of the near-infrared illumination optical unit:

$$TI / TF < 10 ms , and$$

$$RAD ( TI ) * PR < EPS , RAD ( TI ) < 1 / ( 2 * MTFo )$$

$$where$$

$$RAD ( TI ) = Reye * sin ( Ω * TI )$$

$$RAD ( TI ) = Reye * Ω * TI when Ω * TI ≪ 1 ,$$

Reye represents a radius of an eyeball, which has an average value of 12 mm, and Q represents a predetermined eyeball rotation angular velocity, which has a unit of rad/s.

In the embodiments of the present application, the eye/iris image imaging control unit controls the synchronization pulse global exposure period time TI of the imaging system of the eye/iris imaging optical unit to be combined with the LED synchronization pulse illumination radiation period time TF of the near-infrared illumination optical unit to meet the MTFo spatial frequency/resolution requirements of the acceptable permissible eye/iris image quality standard under the condition of motion blur caused by the predetermined eyeball rotation angular velocity.

The problem that the quality of the eye/iris imaging image is affected by complex and powerful stray light including a non-imaging wavelength and an imaging wavelength in an outdoor environment is solved.

In the embodiments of the present application, for a non-imaging wavelength optical signal-to-noise ratio SNRoe, an imaging wavelength optical signal-to-noise ratio SNRoi, and an electrical signal-to-noise ratio SNRei of the eye/iris imaging optical unit,
SNRoe>80 db,
SNRoi>20 db, and
SNRei>40 db.

The near-infrared optical filter of the eye/iris imaging optical unit of the embodiments of the present application employs a narrow-band optical filter to suppress non-imaging wavelength interference, thereby playing a decisive role in improving the optical signal-to-noise ratio SNRoe configuration of the formed image quality. The narrow-band optical filter may be configured with the non-imaging wavelength transmittance which is controlled to be −60 db, that is, below 0.1%.

The near-infrared optical filter 850/940 nm of the eye/iris imaging optical unit may also be of a 30-60 nm narrow band, such that visible light (especially the highlight image display source visible light) is further filtered, near-infrared light is transmitted, and the optical SNRoe of the non-imaging wavelength stray light is increased to improve the noise quality of the formed eye/iris image.

For the eye/iris imaging optical unit, the employed irradiance Eeye/iris generated by an intensity of radiation of an LED light source of the near-infrared illumination optical unit on a surface of the eye/iris is greater than the irradiance Enoise formed by stray light (perpendicular incidence or scattering, reflecting the anisotropic incident noise light rays from all orientations) on the surface of the eye/iris within an imaging wavelength range, that is, Eeye/iris>Enoise.

The intensity of radiation IR of the LED light source of the near-infrared illumination optical unit plays a decisive role in suppressing noise light ray interference within the imaging wavelength range and improving the image quality optical signal-to-noise ratio SNRoi configuration, such that under the condition that a non-coherent light source LED eye biological radiation safety condition is satisfied, the intensity of radiation IR of the LED light source may be configured to the maximum.

According to the embodiments of the present application, the interference of noise light rays within the imaging wavelength range is suppressed, and the optical signal-to-noise ratio of the formed image quality is improved to satisfy the standard that SNRoi>20 db.

In fact, the quality of the imaging wavelength optical signal-to-noise ratio SNRoi may be superimposed to the non-imaging wavelength optical signal-to-noise ratio SNRoe to further improve the non-imaging wavelength optical signal-to-noise ratio.

An upper limit of the irradiance generated by the intensity of radiation IR of the LED light source of the near-infrared illumination optical unit on the surface of the eye/iris, Elimit=IR/Reyerelif²*TF*FP=IR/Reyerelif²*FI<10 mW/cm², thereby ensuring that the biological safety international standard of eye radiation is satisfied.

Furthermore, for a near-eye display scenario, the biometric process time is limited within 10 s, and retinal thermal radiation safety requires that the luminance of radiation (radiance) of the LED light source of the near-infrared illumination optical unit: LR=IR/dA<28000/(dp/Reyerelif²)/cos θr with the unit: mw/sr/cm², where, dA represents a radiating area of the light source, and dp=π*16 mm², which is an exposure area at the maximum pupil.

As an important characteristic of the embodiments of the present application, related to the constant limited FP and Elimit, IR and TF keep an inverse dependence relationship, which means that joint optimization is performed. The lower synchronization pulse global exposure period time TI/synchronization pulse illumination radiation period time TF is, the better a generated controlled motion blur effect is. Moreover, the higher the intensity of radiation IR of the light source is, the more advantageous control and improvement of the non-imaging and imaging wavelength optical signal-to-noise ratios SNRoe/oi are.

In the embodiments of the present application, the pixel luminance Ipixel of a physically imaged eye/iris of the eye/iris imaging optical unit may be configured as follows:
¼MSB<Ipixel<¾MSB, where MSB represents the highest digital gray level in a full scale.

$$Ipixel = Coe * QE * ( Eeye / iris + Enoise ) * {( PS / 1 um )}^{2} * TI * CG * GAIN * ADC ,$$

$$where$$

$$Eeye / iris = IR / {Reyerelif}^{2} ,$$

or, furthermore,

$$Eeye / iris = {cos}^{3} ( θ r ) * IR / {Reyerelif}^{2} = 2 * OP * {cos}^{3} ( θ r ) / π * {( PR / H )}^{2} , and$$

$$H = {( {PX}^{2} + {PY}^{2} )}^{1 / 2} ,$$

where
Ipixel represents the pixel luminance of the physically imaged eye/iris (the unit digital gray level LSB), Coe represents a photoelectric constant of the eye/iris imaging optical unit, and IR represents the intensity of radiation of the LED light source of the near-infrared illumination optical unit, which has the unit of mw/sr. QE represents photon-electron quantum conversion efficiency, which has the unit of e−/(mw*um2)/s, CG represents a conversion gain with the unit of mv/e−, and ADC represents analog voltage/digital luminance conversion, which has the unit of LSB/mv. PD represents a unit pixel density of the image imaging sensor, which has the unit of um/pixel, and GAIN represents an analog gain with the unit of db. H represents the physical number of pixels of the image imaging sensor, which has the unit pixel, and OP represents the optical power of radiation of the LED light source of the near-infrared illumination optical unit, which has the unit of mW.

As a characteristic, Eeye/iris and OP keep in a related constant relationship.

Furthermore, the embodiments of the present application employ the minimized GAIN, which includes, but not limited to, configuration of an analog gain, analog 0 dB and raw 1× are set, thereby reducing electrical noise interference from various sources, improving the contrast of the formed eye/iris image, and ensuring that the electrical signal-to-noise ratio of the formed eye/iris image satisfies SNRei>40 db. After the minimized GAIN is satisfied, furthermore, the conversion gain CG may be configured to be in a linear low conversion gain (LCG) output mode.

The eye/iris image imaging control unit in the example of the embodiments of the present application controls the imaging parameter configuration of an eye/iris image frame, which includes, but not limited to, GAIN,CG,IR,TI/TF,FI,FR/FP, etc.

The eye/iris image imaging control unit functionally controls the eye/iris imaging optical unit and the near-infrared illumination optical unit to generate an eye/iris image in a joint imaging mode, and an image frame period parallel synchronization logical time sequence imaging working mode is employed. For the image frame period parallel synchronization logical time sequence imaging working mode, in a current image frame period time sequence (Tn), the logical time sequence of the next image frame imaging parameter configuration effective period (TAn+1) and/or the next image frame INT exposure integration period (TIn+1)/FLASH synchronous illumination period (TFn+1) is synchronously executed in parallel in the current image frame readout period (TRn), and execution of the current image frame imaging parameter configuration effective period time sequence may be selected prior to the current image frame exposure integration period/synchronous illumination period time sequence. Moreover, an image frame processing calculation period (TCn−1) read by the previous image frame readout period (TRn−1) is performed in a parallel and synchronous superposition manner in the current image frame readout period (TRn).

Such an image frame period parallel synchronization logical time sequence imaging working mode method may be configured with a 100% maximized image frame utilization rate, that is, effective single frame by frame image readout is achieved.

In FIG. 9, a logical time sequence relationship of the image frame period parallel synchronization logical time sequence imaging working mode method is explained in detail.

For a time sequence in FIG. 9, n represents a serial number of a current image frame period, and the current image frame period Tn=TRn.

The current image frame readout period TRn is greater than the next image frame imaging parameter configuration effective period TAn+1 and the next image frame exposure integration period TIn+1/synchronous illumination period TFn+1, i.e., TRn>=TAn+1+TI/TFn+1 is satisfied, and parallel and synchronous execution of the logical time sequences of the next image frame imaging parameter configuration effective period Tan+1 and the next image frame exposure integration period TIn+1/synchronous illumination period TFn+1 is completed in the current image frame readout period TRn.

Moreover, the current image frame readout period TRn is greater than the image frame processing calculation period (TCn−1) read out by the previous image frame readout period (TRn−1), i.e., Tn=TRn>=TCn−1 is satisfied, and parallel and synchronous execution of the logical time sequence of the image frame processing calculation period (TCn−1) read out by the previous image frame readout period (TRn−1) is completed.

According to the above conditions, the time sequence Tn of the current image frame period of the embodiments of the present application satisfies the following conditions:

$$Tn = TRn >= ( TAn + 1 + TI / TFn + 1 ) , and$$

$$Tn = TRn >= TCn - 1.$$

In consideration of the fact that in an actual application scenario, FIG. 9 executes an efficient pipeline parallel processing and image processing flow, furthermore, an image frame processing calculation period (TCn−1) read out by the previous image frame readout period (TRn−1) is executed in a parallel and synchronous superposition manner in the current image frame readout period (TRn) in the example of the embodiments of the present application. It needs to be specifically noted that the next image frame imaging parameter depends on the historical image frame image processing calculation result prediction.

Generally, the eye/iris image imaging control unit employs a constant frame rate, that is, the time sequence Tn of the frame period and the time T of the frame period are required to be kept constant.

According to the above frame period time sequence conditions, the time T of the current frame period of the embodiments of the present application should satisfy the following condition: T>=(TA+TI/TF), and when T=(TA+TI/TF), the frame rate corresponding to T is maximized.

the embodiments of the present application is related described when the equation is true to the maximum extent, which is not limited thereto, and should also be understood equivalently when T>(TA+TI/TF).

The frame rate FR, the synchronous exposure (integration) period frequency, the synchronization pulse illumination radiation period frequency FP, and a duty ratio FI of the eye/iris image imaging control unit within the current image frame period satisfy:

$$FP = FR = 1 / T = 1 / ( TA + TI / TF ) ,$$

$$FI = ( TI / TF ) / T = ( TI / TF ) / ( TA + TI / TF ) , and$$

$$FI = TI / TF * FP / FR .$$

It needs to be specifically noted that TI/TF and FP/FR mean that TI or TF, and FP or FR.

In consideration of the fact that in an actual application scenario, under the equivalent condition and in the equivalent time, the frame period time is inversely proportional to the number of image frames captured by the eye/iris image imaging control unit, the frame rate is directly proportional to the number of image frames captured by the eye/iris image imaging control unit in unit time, which is conductive to improvement of a speed and a subsequent recognition rate.

In the embodiments of the present application, the actual power consumption and image frame rate are considered, which are configured as follows: 30 Hz(fps)<FP/FR<120 Hz(fps), and 3%<FI<30%.

In the embodiments of the present application, wherein the biometric authentication system trains the machine learning model to identify features of eye/iris of individual by analyzing a predetermined set of images of eye/iris of individual via an artificial neural network.

Some particular examples of the embodiments of the present application further includes measurement of individual biological activity of an XR head-mounted display, and such biological activity at least includes instances of physiological features, which include but not limited to:
a pupil constriction or dilation degree and a pupil constriction or dilation rate in response to light ray changes or in response to the particular human eye observation field of view content (visual image), and a contour shape change rate of pupil constriction or dilation, which includes, but not limited to,
a diameter/radius ratio based on a related pupil,
a diameter/radius and time differential ratio based on a related pupil,
outer contour shape change rate counting based on a related pupil, and distance statistical measurement based on each outer contour point of the pupil and the pupil central point;
a range/amplitude, time, frequency and rate of a saccade/an anti-saccade/a microsaccade/a smooth pursuit movement in response to the particular human eye observation field of view content (visual image), which includes, but not limited to, the range/amplitude of peak to peak Vpp or max to min Vmm based on the movement; the time of peak to peak Tpp or max to min Tmm based on the movement; the frequency of peak to peak Fpp or max to min Fmm based on the movement; the rate of the range/amplitude and the time differential ratio based on the movement.
a pupil and/or eye/iris contour shape change rate in response to the particular human eye observation field of view content (visual image), which includes, but not limited to,
outer contour shape change rate counting based on the related pupil and/or eye/iris, and distance statistical measurement based on each outer contour point of the pupil/eye/iris and the pupil/eye/iris central point.

Schematically, distance statistical measurement at least includes, but not limited to,

$$Rave = SUM ( Ri ) / N ,$$

$$Rvar = SUM [ {( Ri - Rave )}^{2} ] / N ,$$

$$Rnorm = Rvar / Rave ,$$

$$Rm = MIN ( Ri ) / MAX ( Ri ) ,$$

$$Rc = [ MAX ( Ri ) - MIN ( Ri ) ] / [ MAX ( Ri ) + MIN ( Ri ) ] , and$$

$$Ri = {[ {( xi - xc )}^{2} + {( yi - xc )}^{2} ]}^{1 / 2 ,}$$

{(Xi,yi)}represents a coordinate set of contour points, (xc, yc) represents coordinates of a central point,

$$xc = SUM ( xi ) / N ,$$

$$yc = SUM ( yi ) / N ,$$

$$i = [ 1 , N ] ,$$

and
N represents the number of contour points.

In some examples, it is further configured: by means of eye tracking, the accuracy and reliability of individual biological activity measurement are improved in response to a real-time gaze movement trajectory of the eyeball of the particular human eye observation field of view content (visual image).

In some examples, the system further includes measurement of individual biological activity of an XR head-mounted display, and such biological activity at least includes polarization degree information of the formed image by configuring the orthogonal state orientation be to combined with polarization state imaging, thereby achieving the measurement of individual biological activity. More orthogonal state orientations are combined with the polarization state imaging to improve the accuracy and reliability of the measurement of individual biological activity.

In some examples, measurement of the physiological state data of the biological individuals of the XR head-mounted display is further included, which may be configured to achieve the functions of inspecting an individual health state and establishing a historical data record file. The physiological state data of the biological individuals includes statistical basis physiological state data of pupil constriction and/or dilation based on light ray changes or the particular human eye observation field of view content (visual image). In some examples, the light ray changes or the particular human eye observation field of view content (visual image) is achieved on the basis of the display imaging optical unit of the XR head-mounted display.

In some examples, the light ray changes or the particular human eye observation field of view content (visual image) may be configured to have a predetermined period time, frequency and luminance, and other various configurable parameter attributes, such as a predetermined period time of 100/200/300/500/1000 ms, predetermined frequency 0.1/0.5/1/2 Hz and predetermined luminance of 0.1/0.5/1 kLUX irradiance to eye.

In some examples, the light ray changes or the particular human eye observation field of view content (visual image) may be configured to respond to binoculus or unilateral eye, and a cross-contrast of the binocular (unilateral and contralateral) physiological state data is separately tested.

The physiological state data of the biological individuals includes, but not limited to:
1. a maximum value Pdil of the related pupil geometric parameter and/or pupil/iris geometric parameter ratio in response to a time point Tdil of pupil dilation state Sd, where in some examples, the pupil/iris geometric parameter includes, but not limited to: a radius, a diameter or a circumference, statistical measurement of a distance from an outer contour to a center, an axis length, an area and other alternative equivalent geometric parameter attribute expressions.
2. a minimum value Pcon of the related pupil geometric parameter and/or pupil/iris geometric parameter ratio in response to a time point Tcon of pupil constriction state Sc, where in some examples, the pupil/iris geometric parameter includes, but not limited to: a radius, a diameter or a circumference, statistical measurement of a distance from an outer contour to a center, an axis length, an area and other alternative equivalent geometric parameter attribute expressions.
3. a response amplitude ds of a value of peak to peak Vpp or a value of max to min Vmm based on a Sd-Sc and/or Sc-Sd period. In some examples, ds specifically includes, but not limited to,

$$ds = ( Pdil - Pcon ) ,$$

or for normalization,

$$ds = ( pdil - pcon ) / pdil .$$

4. a response time dt of time of peak to peak Tpp or time of max to min Tmm based on the Sd-Sc and/or Sc-Sd period. In some examples, dt specifically includes, but not limited to, dt=(Tdil−Tcon).
5. a response change rate dr of the response amplitude ds and the response time dt based on the Sd-Sc and/or Sc-Sd period. In some examples, dr specifically includes, but not limited to, dr=ds/dt.
6. a cross-contrast of the response amplitude ds based on the Sd-Sc and/or Sc-Sd period includes, but not limited to, a related amplitude, related difference of the response amplitude, and/or a related ratio Ads of the response amplitude, which is specifically Ads=(ds1−ds2) and/or Ads=ds1/ds2 Ads=1−ds2/ds1 in some examples,
Where
ds1 represents a response amplitude of a unilateral eye, and
ds2 represents a response amplitude of a contralateral eye.
7. a cross-contrast of the response time dt based on the Sd-Sc and/or Sc-Sd period includes, but not limited to, a related delay, related difference of the response time, and/or related ratio Tdelay of the response time, which is specifically Tdelay=(dt1−dt2) and/or Tdelay=dt1/dt2 Tdelay=1−dt2/dt1 in some examples, where
dt1 represents response time related a unilateral eye, and
dt2 represents response time corresponding to a contralateral eye.
8. a cross-contrast of the response change rate dr based on the Sd-Sc and/or Sc-Sd period includes, but not limited to, related change difference, related difference of the response change rate and/or related ratio Fdr of the response change rate, which is specifically Fdr=(dr1−dr2) and/or Fdr=dr1/dr2 Fdr=1−dr2/dr1 in some examples, where
dr1 represents a response change rate related a unilateral eye, and
dr2 represents a response change rate corresponding to a contralateral eye.

The above-mentioned Sd-Sc period refers to a transition process from a dilated state to a constricted state.

Being alternative and equivalent,
the above-mentioned Sc-Sd period refers to a transition process from a constricted state to a dilated state.
9. a range/amplitude, time, frequency and rate of an saccade/anti-saccade/microsaccade/smooth pursuit movement in response to the particular human eye observation field of view content (visual image), which includes, but not limited to, an angle and time differential ratio based on an angle of the movement and an angle of the movement within the unit time.

In some examples, the above-mentioned one of data attributes are used for the measurement of the physiological state data of the biological individuals. By means of the related biological individual physiological state data reference standard, the health data indicators of the current individual are tested and represented, which further includes, but not limited to, establishing a historical data record file of the current individual physiological state data in a non-volatile storage of a local device or by remotely uploading equivalent to a cloud/server by means of various communication networks so as to be used for a historical data contrast of the current biological individual and provide more medical purposes. In some examples, the related reference standard may contain basic health information of the current biological individual, which includes, but not limited to various physiological health information such as age, gender and basic diseases, thereby further improving the testing precision.

In some examples, the above-mentioned one or more of data attributes may be configured for the measurement of the physiological state data of the biological individuals may be used for biological activity measurement.

It should be noted that the biometric system of the embodiments of the present application includes, but not limited to, individual activity biological features such as an eye/iris, a retina, subcutaneous tissue of eyes, an ophthalmic artery/vein, and a sclera.

In the embodiments of the present application, the examples may also include one or more memory devices, such as memory. Memory generally represents any type or form of volatile or non-volatile storage device or medium capable of storing data and/or computer-readable instructions. In one example, memory may store, load, and/or maintain one or more of modules. Examples of memory include, without limitation, Random Access Memory (RAM), Read Only Memory (ROM), flash memory, Hard Disk Drives (HDDs), Solid-State Drives (SSDs), optical disk drives, caches, variations or combinations of one or more of the equivalent, or any other suitable storage memory.

In the embodiments of the present application, the examples may also include one or more physical processors, such as physical processor. Physical processor generally represents any type or form of hardware-implemented or software-implemented processing unit capable of interpreting and/or executing computer-readable instructions. In one example, physical processor may access and/or modify one or more of modules stored in memory. Additionally or alternatively, physical processor may execute one or more of modules to facilitate authenticating a user of an HMD. Examples of physical processor include, without limitation, microprocessors, microcontrollers, central processing units (CPUs), Field-Programmable Gate Arrays (FPGAs) that implement softcore processors, Application-Specific Integrated Circuits (ASICs), portions of one or more of the equivalent, variations or combinations of one or more of the equivalent, or any other suitable physical processor.

It should be noted that the technical features of the embodiments of the present application are not limited to the application scenarios of narrow head-mounted displays, and all devices with generalized display imaging functions are within the protection scope, such as a three-dimensional (3D) holographic projection devices and an augmented reality-ultra high definition (AR-UHD) device.

The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment.

It needs to be noted that the terms “some” and “at least one” mentioned herein refer to one or more, and the terms “multiple” and “at least two” refer to two or over two. The term “and/or”, which is an association relationship describing an associated object, means that there may be three relationships, for example, A and/or B may represent three situations: A exists alone, A and B exist at the equivalent time, and B exists alone. The character “/” generally represents that successive association objects are in an “or” relationship.

In addition, the terms “a” or “an,” as used in the specification and claims, are to be construed as meaning “at least one of” Finally, for ease of use, the terms “including” and “having” (and their derivatives), as used in the specification and claims, are interchangeable with and have the equivalent meaning as the word “comprising.”

In the description of the present disclosure, it should be also noted that unless expressly specified otherwise, terms are to be understood broadly, for example, components may be fixedly connected, detachably connected or integrally connected. Those of ordinary skill in the art can understand the specific meanings of the terms in the present disclosure in accordance with specific conditions. In the specification of this description, reference terms “embodiments”, “one embodiment”, “some embodiments”, “an embodiment”, “example”, “an example”, “some particular examples”, or “some examples”, etc., mean that a particular feature, structure, material, or characteristic described in conjunction with the embodiment or example is included in at least one embodiment or example of the present disclosure. The above description are merely the examples of the present disclosure, and not intended to limit the present disclosure. Any modifications, equivalent replacements, improvements, etc. made within the principle of the present disclosure should all fall within the protection scope of the present disclosure.

Apparently, the above examples are merely examples given for clearly illustrating the embodiments of the present application, and are not intended to limit the embodiments. For those of ordinary skill in the pertained field, changes or variations in other forms may also be made on the basis of the above description. There are no need and no way to exhaust all the embodiments. Obvious modifications or variations made thereto shall still fall within the protection scope of the embodiments of the present application.

What is claimed is:

1. A biometric system for an extended reality (XR) head-mounted device, comprising: an eye/iris imaging optical unit, a near-infrared illumination optical unit, and an eye/iris image imaging control unit, wherein
the eye/iris imaging optical unit is for physical imaging on eye/iris near-infrared incident light,
the near-infrared illumination optical unit generates related near-infrared light to be emitted to an eye for illuminating an eye/iris, and
the eye/iris image imaging control unit is configured to control the eye/iris imaging optical unit and the near-infrared illumination optical unit to generate an eye/iris image in a joint imaging mode.

2. The biometric system for an XR head-mounted device according to claim 1, further comprising a display imaging optical unit, wherein the display imaging optical unit comprises an image display source and a display imaging assembly, and an image of the image display source is imaged and emitted to an eye through an optical path of the display imaging assembly for image projection.

3. The biometric system for an XR head-mounted device according to claim 2, wherein
illumination parameters configured for the near-infrared illumination optical unit comprises an illumination region (RXr, RYr), a field of view for illumination, FOVr (FOVxr, FOVyr), and an illumination angle of emergence θr, imaging parameters configured for the eye/iris imaging optical unit comprise an imaging region (RXi, RYi), a field of view for imaging, FOVi (FOVxi, FOVyi) and an imaging incident angle θi, and associated global coupling configuration between the illumination parameters and the imaging parameters comprises:
the illumination region (RXr, RYr) at a predetermined distance of the near-infrared illumination optical unit is greater than a predetermined illumination region, and the predetermined illumination region is an eyebox (RXeyebox, RYeyebox) of the display imaging optical unit;
the imaging region (RXi, RYi) at a predetermined distance of the eye/iris imaging optical unit is greater than a determined imaging region, and the determined imaging region is an eyebox (RXeyebox, RYeyebox) of the display imaging optical unit;
the predetermined distance is an eye relief (Reyerelief) of the display imaging optical unit;
the illumination region (RXr, RYr) of the near-infrared illumination optical unit covers and is greater than the imaging region (RXi, RYi) of the eye/iris imaging optical unit;
the near-infrared illumination optical unit controls the field of view for illumination (FOI), FOVr of the near-infrared illumination optical unit through an illumination radiation angle to cover and be greater than the field of view for imaging, FOVi, of the eye/iris imaging optical unit; and
the illumination angle of emergence θr of the near-infrared illumination optical unit is greater than the imaging incident angle θi of the eye/iris imaging optical unit.

4. The biometric system for an XR head-mounted device according to claim 3, wherein the associated global coupling configuration between the illumination parameters and the imaging parameters further comprises:
the illumination region (RXr, RYr) of the near-infrared illumination optical unit is configured as follows:
$$RXr = Kxr * RXeyebox$$
$$RYr = Kyr * RYeyebox$$
$$Kxr = [ 1.2 , 3 ]$$
$$Kyr = [ 1.2 , 3 ]$$
$$or$$
$$RXr = RXeyebox + Fxr * ID$$
$$RYr = RYeyebox + Fyr * ID$$
$$Fxr = [ 0.2 , 2 ]$$
$$Fyr = [ 0.2 , 2 ]$$
the imaging region (RXi, RYi) of the eye/iris imaging optical unit is configured as follows:
$$RXi = Kxi * RXeyebox$$
$$RYi = Kyi * RYeyebox$$
$$Kxi = [ 1.2 , 3 ]$$
$$Kyi = [ 1.2 , 3 ]$$
$$or$$
$$RXi = RXeyebox + Fxi * ID$$
$$RYi = RYeyebox + Fyi * ID$$
$$Fxi = [ 0.2 , 2 ]$$
$$Fyi = [ 0.2 , 2 ]$$
ID represents an iris diameter of an eye and has an average value of 11 mm;
the field of view for illumination, FOVr, of the near-infrared illumination optical unit is configured with field of views in XY horizontal and vertical orientations, FOVxr and FOVyr, wherein
$$FOVxr = 2 * arc tan ( 1 / 2 * RXr / Reyerelif * cos θ r ) ,$$
$$and$$
$$FOVyr = 2 * arc tan ( 1 / 2 * RYr / Reyerelif * cos θ r ) ;$$
the field of view for imaging, FOVi, of the eye/iris imaging optical unit is configured with field of views in XY horizontal and vertical orientations, FOVxi and FOVyi, wherein
$$FOVxi = 2 * arc tan ( 1 / 2 * RXi / Reyerelif * cos θ i ) ,$$
$$and$$
$$FOVyi = 2 * arc tan ( 1 / 2 * RYi / Reyerelif * cos θ i ) ;$$
the imaging incident angle θi of the eye/iris imaging optical unit is configured to be less than a predetermined imaging incident angle θip, that is θi<θip;
the predetermined imaging incident angle θip satisfies the formula: θip=FOVi/2;
the illumination angle for emergence θr of the near-infrared illumination optical unit is configured to be less than a predetermined illumination angle of emergence θrp, that is, θr<θrp; and
the predetermined illumination angle of emergence θrp satisfies the formula: θrp=FOVr/2.

5. The biometric system for an XR head-mounted device according to claim 2, wherein
wherein the eye/iris imaging optical unit is configured to control the imaging region (RXi, RYi) and the field of view for imaging, FOVi, of the eye/iris imaging optical unit through pixel resolution and/or object-image spatial resolution, wherein
$$RXi = PX / PR ,$$
$$RYi = PY / PR ,$$
RXi and RYi represent an imaging region of the field of view for imaging in the X and Y orientations of an object side,
PX and PY represent the pixel resolution in the X and Y orientations of an image side, and
PR represents the object-image spatial resolution;
an effective focal length, EFL, of the eye/iris imaging optical unit is greater than a predetermined imaging focal length β*s/(β−β1) in the eye relief, Reyerelief;
s represents a combined virtual object distance of the eye/iris imaging optical unit;
β=−PR*PS, representing the magnification of a vertical axis of combined imaging for a predetermined image quality standard,
β1 represents the magnification of a vertical axis provided by the imaging optical path of the display imaging assembly,
PS represents the unit pixel resolution with the unit of m/pixel of an image imaging sensor;
an imaging depth of field, RZ, of the eye/iris imaging optical unit is greater than a predetermined imaging depth of field;
the predetermined imaging depth of field is an eye relief, Reyerelief, of the display imaging optical unit;
the imaging depth of field, RZ, of the eye/iris imaging optical unit is configured as follows:
RZ=Kz*Reyerelif, and
Kz=[1,2].

6. The biometric system for an XR head-mounted device according to claim 2, wherein the eye/iris imaging optical unit directly images near-infrared light emitted from the eye/iris, or employs reverse optical/optical path conversion to realize indirect imaging of the near-infrared light emitted from the eye/iris; the reverse optical/optical path conversion is configured to an optical combination with at least once refraction and/or reflection or optical waveguide total internal reflection (TIR) coupling to the imaging optical path of the display imaging assembly and has predetermined optical power for providing virtual distance extension;
the near-infrared illumination optical unit directly illuminates emergent near-infrared light to the eye/iris or indirectly illuminates emergent near-infrared light to the eye/iris using forward optical/optical path conversion; and the forward optical/optical path conversion is configured to an optical combination with at least once refraction and/or reflection or optical waveguide TIR coupling to the imaging optical path of the display imaging assembly and has predetermined optical power for providing virtual distance extension.

7. The biometric system for an XR head-mounted device according to claim 6, wherein
the eye/iris imaging optical unit is combined with a predetermined incident angle/angle of emergence conversion for off-axis optical imaging within a predetermined region/field of view for imaging, FOVi;
the predetermined incident angle/angle of emergence conversion is configured as:
the incident angle and the associated angle of emergence respond to the predetermined angle conversion relationship within a predetermined region/FOVi; and
the predetermined angle conversion relationship is configured as an inverse transformation of optical characteristics responsive to oblique off-axis incidence imaging within a predetermined region/FOVi; and
an imaging optical axis of the predetermined imaging incident angle as a normal axis of a symmetry center.

8. The biometric system for an XR head-mounted device according to claim 6, wherein
the near-infrared illumination optical unit is combined with a predetermined incident angle/angle of emergence conversion for off-axis optical illumination within a predetermined region/field of view for illumination, FOVr; and
the predetermined incident angle/angle of emergence conversion is configured as:
the angle of emergence and an associated incident angle respond to the predetermined angle conversion relationship within a predetermined region/FOVr, and
the predetermined angle conversion relationship is configured as an inverse transformation of optical characteristics responsive to oblique off-axis emergence illumination within a predetermined region/FOVr; and
an illumination optical axis of the predetermined illumination angle of emergence as a normal axis of a symmetry center.

9. The biometric system for an XR head-mounted device according to claim 6, wherein
the optical waveguide TIR is combined with a predetermined incident angle/angle of emergence conversion for optical coupling in/out a TIR angle within a predetermined region/FOV of illumination and imaging.

10. The biometric system for an XR head-mounted device according to claim 1, wherein the near-infrared illumination optical unit and/or the eye/iris imaging optical unit comprises at least one or more metasurface optical elements operating in the NIR wavelength.

11. The biometric system for an XR head-mounted device according to claim 10, wherein the metasurface optical element is configured as a metapolarizer, the metapolarizer is configured to provide illumination and imaging with associated same and/or orthogonal polarization state combination attributes, and the orthogonal polarization state combination attributes are configured to at least one of 0/90, 45/135, LCP/RCP.

12. The biometric system for an XR head-mounted device according to claim 11, wherein a unit array of the metasurface optical element overlays a corresponding unit array of image imaging sensor pixels and is configured to be in the same polarization state or different orientation polarization states, and the different orientation polarization states are configured to be in 0/45/90/135/LCP/RCP respectively, to generate multi-orientation polarization state imaging attributes.

13. The biometric system for an XR head-mounted device of claim 11, wherein the metasurface optical element comprises a substrate and periodic unit cells arranged thereon, and the unit cells comprise tunable subwavelength spatial nanostructure meta-atoms.

14. The biometric system for an XR head-mounted device according to claim 13, wherein the unit cell is configured as a phase retarder responsive to a specific phase shift and/or a polarizer of a specific orientation angle, the phase retarder of the specific phase shift comprises at least one of: 0, ¼, ½ phase retarders, the polarizer of the specific orientation angle comprises: 0/45/90/135/LCP/RCP polarizer, and the meta-atom is configured to respond to an orientation angle of a subwavelength spatial nanostructure of a specific polarization state, light waves of the associated orientation angle pass while light waves of other orientation angles are blocked and shielded.

15. The biometric system for an XR head-mounted device according to claim 10, wherein the metasurface optical element is configured as an off-axis metasurface optical element, the off-axis metasurface optical element is configured as a metaconverter, the metaconverter is configured to be positioned in front of the eye/iris imaging optical unit and to manipulate incident light of the eye/iris imaging optical unit to perform combined optical imaging at a predetermined angle conversion within a predetermined region/field of view for imaging, FOV1.

16. The biometric system for an XR head-mounted device according to claim 15, wherein
the metaconverter is configured as: an incident angle and an associated angle of emergence respond to a predetermined angle conversion relationship within a predetermined region/field of view for imaging, FOVi, and an imaging optical axis of the predetermined imaging incident angle as a normal axis of a symmetry center;
the metaconverter is configured to respond to a wavefront phase modulation function of the predetermined angle conversion relationship within a predetermined region/field of view for imaging, FOVi; and
the predetermined angle conversion relationship is configured as an inverse transformation of optical characteristics responsive to oblique off-axis incidence imaging within a predetermined region/field of view for imaging, FOV1.

17. The biometric system for an XR head-mounted device according to claim 10, wherein the metasurface optical element is configured as an off-axis metasurface optical element, the off-axis metasurface optical element is configured as a metaconverter, the metaconverter is configured to be positioned in front of the illumination optical unit and to manipulate emergent light of the illumination optical unit to perform combined optical illumination at a predetermined angle conversion within a predetermined region/field of view for illumination, FOVr.

18. The biometric system for an XR head-mounted device according to claim 17, wherein
the metaconverter is configured as: an angle of emergence and an associated incident angle respond to a predetermined angle conversion relationship within a predetermined region/field of view for illumination, FOVr, and an illumination optical axis of the predetermined illumination angle of emergence as a normal axis of a symmetry center;
the metaconverter is configured to respond to a wavefront phase modulation function of the predetermined angle conversion relationship within a predetermined region/field of view for illumination, FOVr; and
the predetermined angle conversion relationship is configured as an inverse transformation of optical characteristics responsive to oblique off-axis emergence illumination within a predetermined region/field of view for illumination, FOVr.

19. The biometric system for an XR head-mounted device according to claim 10, wherein the metasurface optical element is configured as a metalens; the metalens is configured to control a wavefront phase state of the incident light to provide physical focus on a pixel unit of the image imaging sensor for focusing to an image plane in a joint imaging mode; and the metalens is configured to control the wavefront phase modulation function to minimize PSF on the image plane within a diffraction limit through a predetermined focal length f, numerical aperture NA, region/field of view for imaging, FOVi, or incident light angle range.

20. The biometric system for an XR head-mounted device according to claim 19, wherein the metapolarizer and the metalens are configured to control the polarization state and the wavefront phase of the incident light in a joint imaging mode through cascade integration to achieve polarization and focusing to a focal plane.

21. The biometric system for an XR head-mounted device according to claim 19, wherein the metaconverter and metalens are configured to control the incident angle and the wavefront phase in a joint imaging mode through cascade integration to achieve conversion and focusing to the image plane.

22. The biometric system for an XR head-mounted device according to claim 10, wherein the metasurface optical element is configured as a metacoupler, and the metacoupler is configured with tunable wavefront phase modulation for tuning an incident angle/angle of emergence conversion to coupling in/out a TIR angle of an optical waveguide within a predetermined region/FOV of illumination and imaging.

23. The biometric system for an XR head-mounted device according to claim 1, wherein the eye/iris image imaging control unit controls imaging parameter setting of image frames of the eye/iris imaging optical unit and the near-infrared illumination optical unit to generate an eye/iris image in a joint imaging mode, and is configured with a working mode of image frame period parallel synchronization logical time sequence imaging; and the image frame period comprises an image frame imaging parameter configuration effective period, an image frame exposure integration period/synchronous illumination period, an image frame readout period and an image frame processing calculation period.

24. The biometric system for an XR head-mounted device according to claim 23, wherein the working mode of image frame period parallel synchronization logical time sequence imaging is configured to synchronously execute the logical time sequence of the next image frame imaging parameter configuration effective period (TAn+1) and/or the next image frame exposure integration period (TIn+1)/synchronous illumination period (TFn+1) in parallel in the current image frame readout period (TRn) in a current image frame period time sequence (Tn), and execute the logical time sequence of the image frame processing calculation period (TCn−1) read by the previous image frame readout period (TRn−1) in a parallel and synchronous superimposed manner.

25. The biometric system for an XR head-mounted device according to claim 23, wherein execution of the time sequence of the image frame imaging parameter configuration effective period has selected prior to the time sequence of the image frame exposure integration period/synchronous illumination period, and the image frame imaging parameter configuration is dependent on historical image frame processing calculation result prediction.

26. The biometric system for an XR head-mounted device according to claim 24, wherein the current image frame readout period TRn is greater than the next image frame imaging parameter configuration effective period TAn+1 and the next image frame exposure integration period TIn+1/synchronous illumination period TFn+1, and
parallel and synchronous execution of the logical time sequences of the next image frame imaging parameter configuration effective period TAn+1 and the next image frame exposure integration period TIn+1/synchronous illumination period TFn+1 is completed in the current image frame readout period TRn; and
the current image frame readout period TRn is greater than the image frame processing calculation period (TCn−1) read by the previous image frame readout period (TRn−1), and
parallel and synchronous execution of the logical time sequence of the image frame processing calculation period (TCn−1) read by the previous image frame readout period (TRn−1) is completed in the current image frame readout period TRn.

27. The biometric system for an XR head-mounted device according to claim 1, wherein
the eye/iris image imaging control unit is configured to control image frame image parameters in a joint imaging mode, the associated global coupling of image frame imaging parameter configuration comprises at least one or more: time T of the image frame period, time TA of the image frame imaging parameter configuration effective period, time TR of image frame readout period, time TC of the image frame processing calculation period, and an intensity of radiation, IR, of the near-infrared illumination optical unit,
time TI of a synchronization pulse global exposure integration period of the eye/iris imaging optical unit, and time TF of a synchronization pulse illumination radiation period of the near-infrared illumination optical unit;
an image frame rate FR, a frequency of the synchronization pulse global exposure integration period, a frequency FP of the synchronization pulse illumination radiation period, and a duty ratio FI;
the time TI of the synchronization pulse global exposure integration period is configured to be equal to the time TF of the synchronization pulse illumination radiation period;
the image frame rate FR is configured to be equal to the frequency of the synchronization pulse global exposure integration period and the frequency FP of the synchronization pulse illumination radiation period; and
the intensity of radiation, IR, of the near-infrared illumination optical unit and the time TF of the synchronization pulse illumination radiation period are configured as follows:
IR and TF keep inverse correlated for executing joint optimization.

28. The biometric system for an XR head-mounted device according to claim 27,
wherein the image frame imaging parameters are configured as follows:
$$T = TR >= ( TA + TI / TF )$$
$$T = TR >= TC$$
$$FP = FR = 1 / T ,$$
$$and$$
$$FI = ( TI / TF ) / T = TI / TF * FP / FR .$$

29. The biometric system for an XR head-mounted device according to claim 27, wherein the time TI of the synchronization pulse global exposure integration period is configured as follows:
TI<10 ms, and
TI meets the requirement that the associated motion blur is below the reciprocal of an acceptable spatial frequency/resolution of a permissible eye/iris image quality standard;
the image frame rate FR, the frequency of the synchronization pulse global exposure integration period, the frequency FP of the synchronization pulse illumination radiation period, and the duty ratio FI are configured as follows:
30 Hz(fps)<FP/FR<120 Hz(fps), and 3%<FI<30%.

30. The biometric system for an XR head-mounted device according to claim 29, wherein
the associated motion blur is proportional to TI and a predetermined eyeball rotation angular velocity Ω; and
the the motion blur is configured with RAD(TI) as follows:
$$RAD ( TI ) * PR < EPS ,$$
$$RAD ( TI ) < 1 / ( 2 * MTFo ) ,$$
$$wherein$$
$$RAD ( TI ) = Reye * sin ( Ω * TI )$$
$$RAD ( TI ) = Reye * Ω * TI$$
$$when$$
$$Ω * TI ≪ 1 ,$$
$$and$$
$$EPS = PR / ( 2 * MTFo ) .$$

31. The biometric system for an XR head-mounted device according to claim 27, wherein
the near-infrared illumination optical unit is configured as follows: irradiance and optical power of radiation generated on a surface of the eye/iris keep a correlated constant relationship; and greater than the irradiance formed by stray light within an imaging wavelength range.

32. The biometric system for an XR head-mounted device according to claim 27, wherein
the imaging parameter configuration comprises at least one or more data attributes:
a predetermined pixel scale EPS associated with image quality standard conversion;
predetermined imaging system pixel TV distortion Distv;
predetermined imaging system relative illuminance RI;
a predetermined imaging system modulation transfer function value MTF;
a predetermined imaging system aperture F;
predetermined imaging system depth of field DOFi;
a predetermined imaging system non-imaging wavelength optical signal-to-noise ratio SNRoe, imaging wavelength optical signal-to-noise ratio SNRoi, and electrical signal-to-noise ratio SNRei;
predetermined pixel luminance Ipixel of a physically imaged eye/iris of the imaging system;
the predetermined pixel scale EPS associated with image quality standard conversion:
$$EPS = PR / ( 2 * MTFo )$$
MTFo represents a modulation transfer function value of the object spatial resolution/frequency of the eye/iris image quality at predetermined contrast;
the predetermined imaging system pixel TV distortion is configured as follows:
$$Distv < 5 \% @ 1. FOVi ;$$
the predetermined imaging system relative illuminance is configured as follows:
$$RI = RIled * RIlens ,$$
$$RI > 30 \% @ 1. FOVi ,$$
RIled represents the relative illuminance when an illumination radiation angle of the near-infrared illumination optical unit is 1.0 FOVi, and
RIlens represents the relative illuminance when a field of view of an imaging lens of the eye/iris imaging optical unit is 1.0 FOVi;
the predetermined imaging system modulation transfer function value is configured as follows: MTF=MTFsensor*MTFlens,
$$MTF > 50 \% or {e}^{1 / 2} \% @ PF$$
$$PF = Nyquist / EPS = 1 / ( 2 * PS * EPS ) ,$$
PF represents the image spatial resolution/frequency,
MTFsensor represents a modulation transfer function value of the image imaging sensor of the eye/iris imaging optical unit at PF, and
MTFlens represents a modulation transfer function value of the imaging lens of the eye/iris imaging optical unit at PF;
the predetermined imaging system aperture F is configured as follows:
$$F = m * PS = [ 1 / 8 , 1 / 2 ] * ( PS * PR / MTFo ) / um ,$$
$$and$$
$$m = [ EPS / 8 , EPS / 2 ] / um$$
the predetermined imaging depth of field is configured as follows:
$$DOFi >= 2 * m * EPS / {PR}^{2} = m / ( MTFo * PR ) = [ 1 / 16 , 1 / 4 ] * ( 1 / {MTFo}^{2} ) / um ;$$
the determined imaging system non-imaging wavelength optical signal-to-noise ratio SNRoe, imaging wavelength optical signal-to-noise ratio SNRoi, and electrical signal-to-noise ratio SNRei are configured as follows:
SNRoe>80 db,
SNRoi>20 db, and
SNRei>40 db; and
the pixel luminance Ipixel of a physically imaged eye/iris of the imaging system is configured as follows:
¼MSB<Ipixel<¾MSB, wherein MSB represents the highest digital gray scale in a full scale.

33. An XR head-mounted device, being applied to biometrics of at least one of an eye/iris, a retina, subcutaneous tissue of eyes, an ophthalmic artery/vein, and a sclera in the biometric system for an XR head-mounted device according to claim 1.

34. An XR head-mounted device, being multiplexed for eye tracking by the biometric system for an XR head-mounted device according to claim 1.
